(19) United States
(12) Patent Application Publication
(10) Pub. No.: US 2012/0132855 A1
(43) Pub. Date: May 31, 2012

(54) LIQUID CRYSTAL COMPOSITION AND LIQUID CRYSTAL DISPLAY DEVICE

(75) Inventors: Tetsuji Ishitani, Atsugi (JP); Sachiko Kawakami, Atsugi (JP); Yuko Kawata, Atsugi (JP); Manabu Kobayashi, Atsugi (JP); Momoko Kato, Zama (JP); Satoshi Seo, Sagamihara (JP)

(73) Assignee: SEMICONDUCTOR ENERGY LABORATORY CO., LTD., Atsugi-shi (JP)

(21) Appl. No.: 13/299,701

(22) Filed: Nov. 18, 2011

(30) Foreign Application Priority Data
Nov. 26, 2010 (JP) 2010-263468

(51) Int. Cl. C09K 19/20; C09K 19/54; C09K 19/24; C09K 19/12; C09K 19/30

(52) U.S. Cl. 252/299.63; 252/299.66; 252/299.6; 252/299.67; 252/299.68

(57) ABSTRACT

To provide a liquid crystal composition exhibiting a blue phase, which enables higher contrast, and a liquid crystal display device including the liquid crystal composition. The liquid crystal composition contains a chiral agent and liquid crystal containing a compound having three electron-withdrawing groups as end groups of a structure where a plurality of rings including at least one aromatic ring is linked to each other directly or with a linking group laid therebetween. The peak of the diffracted wavelength on the longest wavelength side in the reflectance spectrum of the liquid crystal composition is less than or equal to 450 nm, preferably less than or equal to 420 nm. Further, a liquid crystal display device can be provided using the liquid crystal composition.

### BACKGROUND OF THE INVENTION

1. Field of the Invention

The present invention relates to a liquid crystal composition, a liquid crystal display device, and a manufacturing method thereof.

2. Description of the Related Art

As a display device which is thin and lightweight (a so-called flat panel display), a liquid crystal display device including a liquid crystal element, a light-emitting device including a self light-emitting element, a field emission display (an FED), and the like have been competitively developed.

In a liquid crystal display device, response speed of liquid crystal molecules is required to be increased. Among various kinds of display modes of liquid crystal, liquid crystal modes capable of high-speed response are a ferroelectric liquid crystal (FLC) mode, an optical compensated bend (OCB) mode, and a mode using liquid crystal exhibiting a blue phase.

In particular, the mode using liquid crystal exhibiting a blue phase does not require an alignment film and provides a wide viewing angle, and thus has been developed more actively for practical use (see Patent Documents 1 and 2, for example).

### REFERENCE

[Patent Document 1] PCT International Publication No. 2005-090520
[Patent Document 2] Japanese Published Patent Application No. 2008-303381

### SUMMARY OF THE INVENTION

An object is to provide a liquid crystal composition exhibiting a blue phase, which enables higher contrast, and a liquid crystal display device including the liquid crystal composition.

One embodiment of the invention disclosed in this specification is a liquid crystal composition which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm.

In the compound having three electron-withdrawing groups as end groups of a structure where a plurality of rings including at least one aromatic ring is linked to each other directly or with a linking group laid therebetween, the plurality of rings may include cycloalkane. Further, it is preferable that a benzene ring have the electron-withdrawing groups as substituents. As the electron-withdrawing group, a cyano group or fluorine can be used.

The compound having three electron-withdrawing groups as end groups of a structure where a plurality of rings including at least one aromatic ring is linked to each other directly or with a linking group laid therebetween can be contained in the liquid crystal at 40 wt % or more.

A blue phase is exhibited in a liquid crystal composition having strong twisting power and the structure of the liquid crystal composition has a double twist structure. The liquid crystal composition shows a cholesteric phase, a cholesteric blue phase, an isotropic phase, or the like depending on conditions.

A cholesteric blue phase which is a blue phase includes three structures of blue phase I, blue phase II, and blue phase III from the low temperature side. A cholesteric blue phase which is a blue phase is optically isotropic, and blue phase I and blue phase II have body-centered cubic symmetry and simple cubic symmetry, respectively. In the cases of blue phase I and blue phase II, Bragg diffraction is seen in the range from ultraviolet light to visible light.

As the indicators of the strength of twisting power, the helical pitch, the selective reflection wavelength, HTP (helical twisting power), and the diffracted wavelength are given, and among them, the helical pitch, the selective reflection wavelength, and HTP are used for evaluation of a cholesteric phase. On the other hand, the diffracted wavelength can be used for only evaluation of a blue phase, so that it is effective for evaluation of the twisting power of a blue phase. In the reflectance spectrum of a liquid crystal composition measured within the temperature range where the liquid crystal composition exhibits a blue phase, as the diffracted wavelength is on the shorter wavelength side, the liquid crystal composition has a smaller crystal lattice of a blue phase and stronger twisting power.

In the liquid crystal composition, the peak of the diffracted wavelength on the longest wavelength side in the reflectance spectrum is less than or equal to 450 nm, preferably less than or equal to 420 nm, and the twisting power is strong. When the twisting power of the liquid crystal composition is strong, the transmittance of the liquid crystal composition in application of no voltage (at an applied voltage of 0 V) can be low, leading to a higher contrast of a liquid crystal display device including the liquid crystal composition.

The chiral agent is used to induce twisting of the liquid crystal composition, align the liquid crystal composition in a helical structure, and make the liquid crystal composition exhibit a blue phase. For the chiral agent, a compound which has an asymmetric center, high compatibility with the liquid crystal composition, and strong twisting power is used. In addition, the chiral agent is an optically active substance; a higher optical purity is better and the most preferable optical purity is 99% or higher.

Since the liquid crystal composition has strong twisting power, the chiral agent can be contained in the liquid crystal composition at 10 wt % or less. When a large amount of chiral agent is added to improve the twisting power of the liquid crystal composition, driving voltage applied to drive the liquid crystal composition might increase. As in the liquid crystal composition, reduction in the amount of chiral agent to be added allows decrease in driving voltage, resulting in lower power consumption.

A liquid crystal composition exhibiting a blue phase has an optical modulation property. It is optically isotropic in application of no voltage, whereas it becomes optically anisotropic when the alignment order changes by voltage application. The liquid crystal composition which exhibits a blue phase can be used for a liquid crystal display device. One embodiment of the invention disclosed in this specification is a liquid crystal display device including the liquid crystal composition exhibiting a blue phase.

In the liquid crystal display device, the peak of the diffracted wavelength on the longest wavelength side in the reflectance spectrum of the liquid crystal composition is preferably less than or equal to 450 nm, more preferably less than or equal to 420 nm.

In this specification, the peak of the diffracted wavelength of 450 nm or less (preferably 420 nm or less) in the reflectance spectrum of a liquid crystal composition refers to the peak with the maximum value (the value at the top of the peak) on the longest wavelength side. Thus, in the case where the reflectance spectrum has a plurality of peaks, the peak with the maximum value on the longest wavelength side is the peak of the diffracted wavelength even if the peak has a shoulder (a level difference or a low peak).

A blue phase is optically isotropic and thus has no viewing angle dependence. Thus, an alignment film is not necessarily formed, which enables improvement in display image quality and cost reduction.

In a liquid crystal display device, it is preferable that a polymerizable monomer be added to a liquid crystal composition and polymer stabilization treatment be performed in order to broaden the temperature range within which a blue phase is exhibited. As the polymerizable monomer, for example, a thermopolymerizable monomer which can be polymerized by heat, a photopolymerizable monomer which can be polymerized by light, or a polymerizable monomer which can be polymerized by heat and light can be used. Further, a polymerization initiator may be added to the liquid crystal composition.

For example, polymer stabilization treatment can be performed in such a manner that a photopolymerizable monomer and a photopolymerization initiator are added to the liquid crystal composition and the liquid crystal composition is irradiated with light having a wavelength at which the photopolymerizable monomer and the photopolymerization initiator react with each other. When a UV-polymerizable monomer is used as a photopolymerizable monomer, the liquid crystal composition may be irradiated with ultraviolet light.

The liquid crystal composition which exhibits a blue phase is capable of high-speed response. Thus, a high-performance liquid crystal display device can be realized.

A liquid crystal composition which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm, has strong twisting power; therefore, the transmittance of the liquid crystal composition in application of no voltage (at an applied voltage of 0 V) can be low.

When the liquid crystal composition exhibiting a blue phase is used, high contrast can be achieved, which makes it possible to provide a liquid crystal display device having a high level of visibility and high image quality.

### BRIEF DESCRIPTION OF THE DRAWINGS

In the accompanying drawings:

FIG. 1 is a conceptual view illustrating a liquid crystal composition;

FIGS. 2A and 2B illustrate one mode of a liquid crystal display device;

FIGS. 3A to 3D each illustrate one mode of an electrode structure of a liquid crystal display device;

FIGS. 4A and 4B illustrate one mode of a liquid crystal display device;

FIGS. 5A to 5D each illustrate one mode of an electrode structure of a liquid crystal display device;

FIGS. 6A and 6B illustrate one mode of a liquid crystal display device;

FIGS. 7A1, 7A2, and 7B illustrate liquid crystal display modules;

FIGS. 8A and 8B illustrate an electronic device and block diagrams thereof, respectively;

FIGS. 9A to 9F illustrate electronic devices;

FIG. 10 shows reflectance spectra of liquid crystal compositions;

FIG. 11 shows reflectance spectra of liquid crystal compositions;

FIG. 12 shows reflectance spectra of liquid crystal compositions;

FIGS. 13A and 13B show the relation between applied voltage and transmittance in a liquid crystal element;

FIGS. 14A and 14B show the relation between applied voltage and contrast ratio in a liquid crystal element;

FIGS. 15A to 15C are ¹H NMR charts of CPP-3FCNF;

FIGS. 16A to 16C are ¹H NMR charts of CPP-3FFF;

FIGS. 17A to 17C are ¹H NMR charts of CPP-3CN;

FIGS. 18A to 18C are ¹H NMR charts of CPEP-5FCNF;

FIGS. 19A to 19C are ¹H NMR charts of PEP-3FCNF;

FIGS. 20A to 20C are ¹H NMR charts of CPEP-5CNF; and

FIGS. 21A to 21C are ¹H NMR charts of PEP-3CNF.

### DETAILED DESCRIPTION OF THE INVENTION

Embodiments and examples will be described in detail with reference to the accompanying drawings. Note that the present invention is not limited to the description below, and it is easily understood by those skilled in the art that a variety of changes and modifications can be made without departing from the spirit and scope of the present invention. Therefore, the present invention should not be construed as being limited to the descriptions of the embodiments and the examples below. In the structures to be given below, the same portions or portions having similar functions are denoted by the same reference numerals in different drawings, and descriptions thereof will not be repeated.

Note that the ordinal numbers such as “first”, “second”, and “third” in this specification are used for convenience and do not denote the order of steps and the stacking order of layers. In addition, the ordinal numbers in this specification do not denote particular names which specify the present invention.

In this specification, a semiconductor device means a general device which can function by utilizing semiconductor characteristics, and an electrooptic device, a semiconductor circuit, and an electronic device are all semiconductor devices.

### Embodiment 1

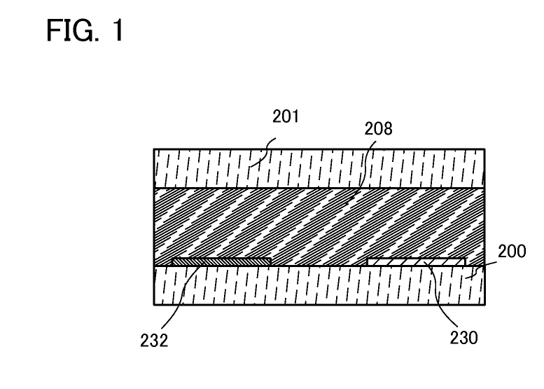

A liquid crystal composition according to one embodiment of the structure of the invention disclosed in this specification, and a liquid crystal display device including the liquid crystal composition will be described with reference to FIG. 1. FIG. 1 is a cross-sectional view of a liquid crystal display device.

The liquid crystal composition according to this embodiment is a liquid crystal composition which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm.

In the compound having three electron-withdrawing groups as end groups of a structure where a plurality of rings including at least one aromatic ring is linked to each other directly or with a linking group laid therebetween, the plurality of rings may include cycloalkane. It is preferable that a benzene ring have the electron-withdrawing groups as substituents.

As the electron-withdrawing group as an end group of a structure where a plurality of rings including at least one aromatic ring is linked to each other directly or with a linking group laid therebetween, a cyano group or fluorine can be used. The three electron-withdrawing groups may be all cyano groups, all fluorine, or any combination of cyano group and fluorine.

In the liquid crystal composition, the plurality of rings including at least one aromatic ring may be linked to each other directly or with a linking group laid between the rings. The linking group is a bivalent group. Specific examples of the linking group are as follows: an ester group represented by a structural formula (1); an ethyne-1,2-diyl group represented by a structural formula (2); an aldimine-1,2-diyl group represented by a structural formula (3); an azo group represented by a structural formula (4); a difluoromethylether-1,2-diyl group represented by a structural formula (5); a methylether-1,2-diyl group represented by a structural formula (6); and an ethane-1,2-diyl group represented by a structural formula (7). As for the ester group, the aldimine-1,2-diyl group, the difluoromethylether-1,2-diyl group, and the methylether-1,2-diyl group among the above linking groups, the direction of link may be any direction. Further, the aldimine-1,2-diyl group and the azo group are preferably in the trans form.

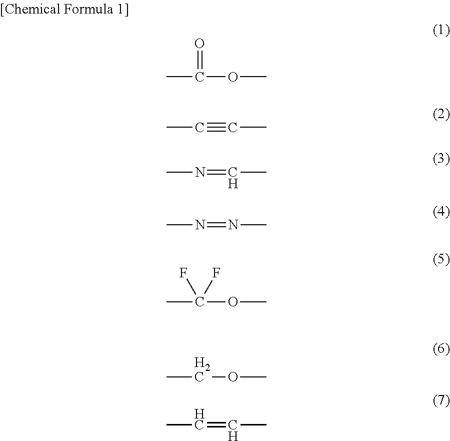

Specific examples of a compound including a trisubstituted benzene ring with electron-withdrawing groups are as follows: 4-[4-(trans-4-n-propylcyclohexyl)phenyl]-2,6-difluorobenzonitrile (abbreviation: CPP-3FCNF) represented by a structural formula (101); 4-(trans-4-n-propylcyclohexyl)-3′,4′,5′-trifluoro-1,1′-biphenyl (abbreviation: CPP-3FFF) represented by a structural formula (102); 4-(trans-4-n-pentylcyclohexyl)benzoic acid 4-cyano-3,5-difluorophenyl (abbreviation: CPEP-5FCNF) represented by a structural formula (103); and 4-n-propyl benzoic acid 3,5-difluoro-4-cyanophenyl (abbreviation: PEP-3FCNF) represented by a structural formula (104). Note that one embodiment of the present invention is not limited to these.

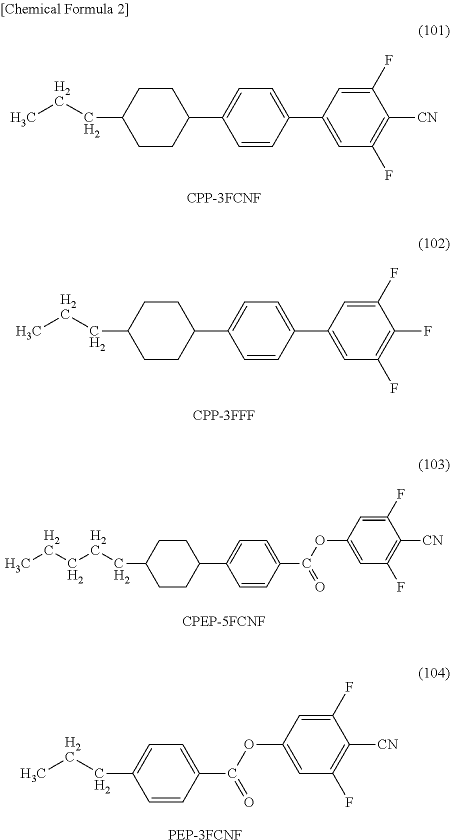

The compound having three electron-withdrawing groups as end groups of a structure where a plurality of rings including at least one aromatic ring is linked to each other directly or with a linking group laid therebetween can be contained in the liquid crystal at 40 wt % or more.

In the liquid crystal composition, the peak of the diffracted wavelength on the longest wavelength side in the reflectance spectrum is less than or equal to 450 nm, preferably less than or equal to 420 nm, and the twisting power is strong. When the twisting power of the liquid crystal composition is strong, the transmittance of the liquid crystal composition in application of no voltage (at an applied voltage of 0 V) can be low, leading to a higher contrast of a liquid crystal display device including the liquid crystal composition.

The chiral agent is used to induce twisting of the liquid crystal composition, align the liquid crystal composition in a helical structure, and make the liquid crystal composition exhibit a blue phase. For the chiral agent, a compound which has an asymmetric center, high compatibility with the liquid crystal composition, and strong twisting power is used. In addition, the chiral agent is an optically active substance; a higher optical purity is better and the most preferable optical purity is 99% or higher.

In the liquid crystal composition according to this embodiment, the peak of the diffracted wavelength on the longest wavelength side in the reflectance spectrum is a short wavelength of less than or equal to 450 nm, preferably less than or equal to 420 nm; thus, the twisting power is strong. Accordingly, the amount of chiral agent to be added can be reduced. For example, the chiral agent may be contained in the liquid crystal composition at 10 wt % or less. When a large amount of chiral agent is added to improve the twisting power of the liquid crystal composition, driving voltage applied to drive the liquid crystal composition might increase. Reduction in the amount of chiral agent to be added allows decrease in driving voltage, resulting in lower power consumption.

The liquid crystal composition which exhibits a blue phase, which is disclosed in this specification, can be used for a liquid crystal display device.

A blue phase is optically isotropic and thus has no viewing angle dependence. Thus, an alignment film is not necessarily formed, which enables improvement in display image quality and cost reduction.

In a liquid crystal display device, it is preferable that a polymerizable monomer be added to a liquid crystal composition and polymer stabilization treatment be performed in order to broaden the temperature range within which a blue phase is exhibited. As the polymerizable monomer, for example, a thermopolymerizable (thermosetting) monomer which can be polymerized by heat, a photopolymerizable (photocurable) monomer which can be polymerized by light, or a polymerizable monomer which can be polymerized by heat and light can be used. Further, a polymerization initiator may be added to the liquid crystal composition.

The polymerizable monomer may be a monofunctional monomer such as acrylate or methacrylate; a polyfunctional monomer such as diacrylate, triacrylate, dimethacrylate, or trimethacrylate; or a mixture thereof. Further, the polymerizable monomer may have liquid crystallinity, non-liquid crystallinity, or both of them.

As the polymerization initiator, a radical polymerization initiator which generates radicals by light irradiation, an acid generator which generates an acid by light irradiation, or a base generator which generates a base by light irradiation may be used.

For example, polymer stabilization treatment can be performed in such a manner that a photopolymerizable monomer and a photopolymerization initiator are added to the liquid crystal composition and the liquid crystal composition is irradiated with light having a wavelength at which the photopolymerizable monomer and the photopolymerization initiator react with each other. When a UV polymerizable monomer is used as a photopolymerizable monomer, the liquid crystal composition may be irradiated with ultraviolet light.

This polymer stabilization treatment may be performed on a liquid crystal composition exhibiting an isotropic phase or a liquid crystal composition exhibiting a blue phase under the control of the temperature. A temperature at which the phase changes from a blue phase to an isotropic phase when the temperature rises, or a temperature at which the phase changes from an isotropic phase to a blue phase when the temperature falls is referred to as the phase transition temperature between a blue phase and an isotropic phase. For example, the polymer stabilization treatment can be performed in the following manner: after a liquid crystal composition to which a photopolymerizable monomer is added is heated to exhibit an isotropic phase, the temperature of the liquid crystal composition is gradually lowered so that the phase changes to a blue phase, and then, light irradiation is performed while the temperature at which a blue phase is exhibited is kept.

FIG. 1 illustrates an example in which the liquid crystal composition which exhibits a blue phase, which is disclosed in this specification, is used for a liquid crystal display device.

FIG. 1 illustrates a liquid crystal display device in which a first substrate 200 and a second substrate 201 are positioned so as to face each other with a liquid crystal composition 208 which is a liquid crystal composition which exhibits a blue phase interposed between the first substrate 200 and the second substrate 201. A pixel electrode layer 230 and a common electrode layer 232 are provided between the first substrate 200 and the liquid crystal composition 208 so as to be adjacent to each other.

In a liquid crystal display device including a liquid crystal composition which exhibits a blue phase, a method can be used in which the gray scale is controlled by moving liquid crystal molecules in a plane parallel to the substrate with the application of an electric field parallel to or substantially parallel to a substrate (i.e., in the lateral direction).

The pixel electrode layer 230 and the common electrode layer 232, which are adjacent to each other with the liquid crystal composition 208 interposed therebetween, have a distance at which liquid crystal in the liquid crystal composition 208 between the pixel electrode layer 230 and the common electrode layer 232 responds to a predetermined voltage which is applied to the pixel electrode layer 230 and the common electrode layer 232. The voltage applied is controlled as appropriate depending on the distance.

The maximum thickness (film thickness) of the liquid crystal composition 208 is preferably greater than or equal to 1 μm and less than or equal to 20 μm.

The liquid crystal composition 208 can be formed by a dispenser method (a dropping method), or an injection method by which liquid crystal is injected using capillary action or the like after the first substrate 200 and the second substrate 201 are attached to each other.

As the liquid crystal composition 208, a liquid crystal composition which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm, is used. Further, the liquid crystal composition provided as the liquid crystal composition 208 may contain an organic resin.

With an electric field generated between the pixel electrode layer 230 and the common electrode layer 232, liquid crystal is controlled. An electric field in the lateral direction is generated for the liquid crystal, so that liquid crystal molecules can be controlled using the electric field. Since the liquid crystal molecules aligned so that a blue phase is exhibited can be controlled in the direction parallel to the substrate, a wide viewing angle is obtained.

In the liquid crystal composition according to this embodiment, the peak of the diffracted wavelength on the longest wavelength side in the reflectance spectrum is less than or equal to 450 nm, preferably less than or equal to 420 nm, and the twisting power is strong. When the twisting power of the liquid crystal composition is strong, the transmittance of the liquid crystal composition in application of no voltage (at an applied voltage of 0 V) can be low, leading to a higher contrast of a liquid crystal display device including the liquid crystal composition. An increase in contrast makes it possible to provide a liquid crystal display device having a high level of visibility and high image quality.

The liquid crystal composition which exhibits a blue phase is capable of high-speed response. Thus, a high-performance liquid crystal display device can be realized.

For example, such a liquid crystal composition exhibiting a blue phase, which is capable of high-speed response, can be favorably used for a successive additive color mixing method (a field sequential method) in which light-emitting diodes (LEDs) of RGB or the like are arranged in a backlight unit and color display is performed by time division, or a three-dimensional display method using a shutter glasses system in which images for a right eye and images for a left eye are alternately viewed by time division.

Although not illustrated in FIG. 1, an optical film such as a polarizing plate, a retardation plate, or an anti-reflection film, or the like is provided as appropriate. For example, circular polarization with the polarizing plate and the retardation plate may be used. In addition, a backlight or the like can be used as a light source.

In this specification, a substrate provided with a semiconductor element (e.g., a transistor), a pixel electrode layer, and a common electrode layer is referred to as an element substrate (a first substrate), and a substrate which faces the element substrate with a liquid crystal composition interposed therebetween is referred to as a counter substrate (a second substrate).

The liquid crystal composition which exhibits a blue phase, which is disclosed in this specification, is used for a liquid crystal display device. Thus, a transmissive liquid crystal display device in which display is performed by transmission of light from a light source, a reflective liquid crystal display device in which display is performed by reflection of incident light, or a transflective liquid crystal display device in which a transmissive type and a reflective type are combined can be provided.

In the case of the transmissive liquid crystal display device, a first substrate, a second substrate, and other components such as an insulating film and a conductive film which are provided in a pixel region through which light is transmitted transmit light in the visible wavelength range. It is preferable that the pixel electrode layer and the common electrode layer transmit light; however, if an opening pattern is provided, a non-light-transmitting material such as a metal film may be used depending on the shape.

On the other hand, in the case of the reflective liquid crystal display device, a reflective component which reflects light transmitted through the liquid crystal composition (e.g., a reflective film or substrate) may be provided on the side opposite to the viewing side of the liquid crystal composition. Therefore, a substrate, an insulating film, and a conductive film which are provided between the viewing side and the reflective component and through which light is transmitted have a light-transmitting property with respect to light in the visible wavelength range. Note that in this specification, a light-transmitting property refers to a property of transmitting at least light in the visible wavelength range.

The pixel electrode layer 230 and the common electrode layer 232 may be formed using one or more of the following: indium tin oxide (ITO), a conductive material in which zinc oxide (ZnO) is mixed into indium oxide, a conductive material in which silicon oxide (SiO₂) is mixed into indium oxide, organoindium, organotin, indium oxide containing tungsten oxide, indium zinc oxide containing tungsten oxide, indium oxide containing titanium oxide, and indium tin oxide containing titanium oxide; graphene; metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and metal nitrides thereof.

As the first substrate 200 and the second substrate 201, a glass substrate of barium borosilicate glass, aluminoborosilicate glass, or the like, a quartz substrate, a plastic substrate, or the like can be used.

In the liquid crystal composition according to this embodiment, the peak of the diffracted wavelength on the longest wavelength side in the reflectance spectrum is less than or equal to 450 nm, preferably less than or equal to 420 nm, and the twisting power is strong. Thus, the transmittance of the liquid crystal composition in application of no voltage (at an applied voltage of 0 V) can be low.

Thus, with the use of the liquid crystal composition which exhibits a blue phase, a liquid crystal display device with higher contrast can be provided.

This embodiment can be implemented in appropriate combination with any of the structures described in the other embodiments.

### Embodiment 2

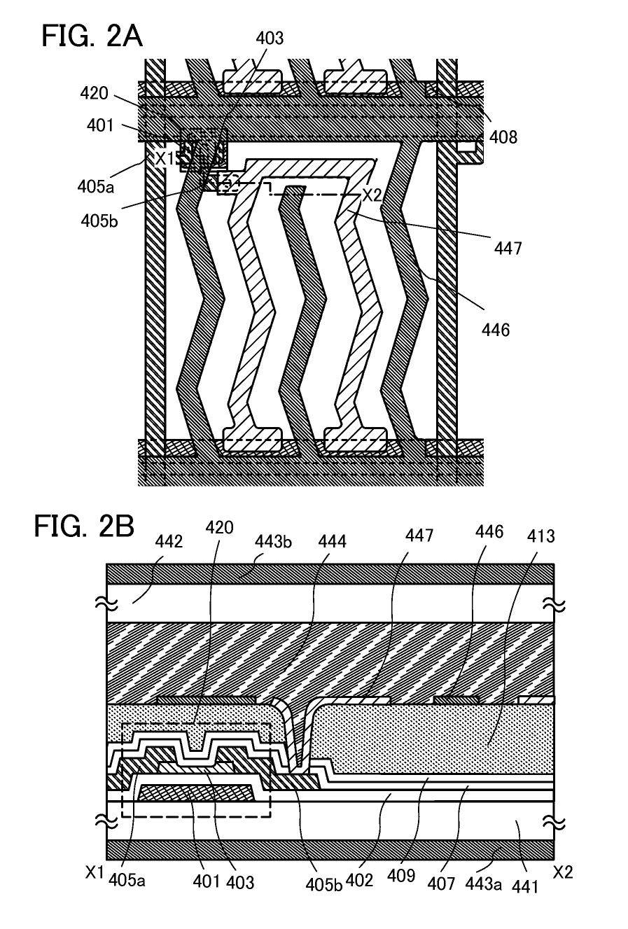

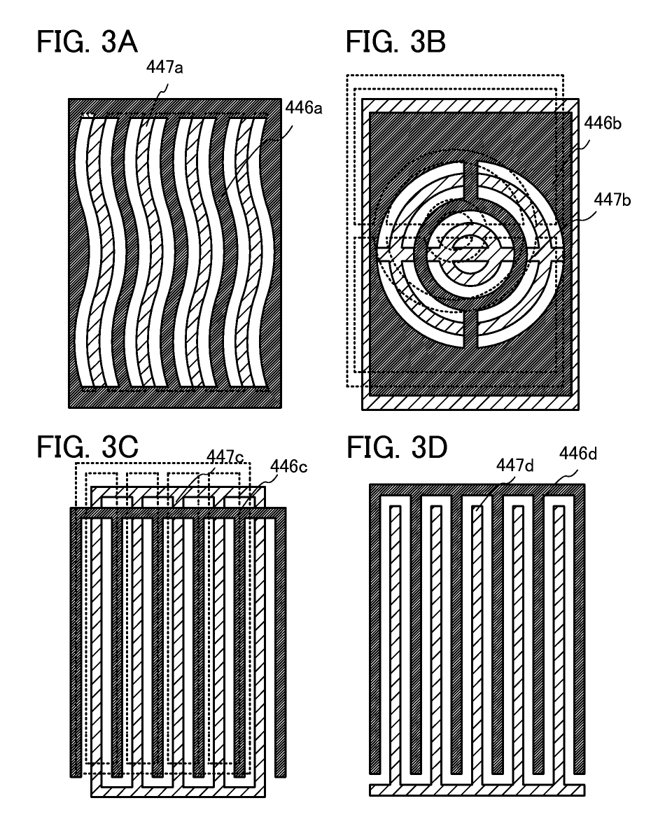

The invention disclosed in this specification can be applied to both a passive matrix liquid crystal display device and an active matrix liquid crystal display device. In this embodiment, an example of an active matrix liquid crystal display device to which the invention disclosed in this specification is applied will be described with reference to FIGS. 2A and 2B and FIGS. 3A and 3D.

FIG. 2A is a plan view of the liquid crystal display device and illustrates one pixel. FIG. 2B is a cross-sectional view along X1-X2 in FIG. 2A.

In FIG. 2A, a plurality of source wiring layers (including a wiring layer 405a) is arranged so as to be parallel to (extend in the longitudinal direction in the drawing) and apart from each other. A plurality of gate wiring layers (including a gate electrode layer 401) is arranged so as to be extended in a direction perpendicular to or substantially perpendicular to the source wiring layers (in the horizontal direction in the drawing) and apart from each other. Common wiring layers 408 are provided so as to be adjacent to the corresponding gate wiring layers and extended in a direction parallel to or substantially parallel to the gate wiring layers, that is, in a direction perpendicular to or substantially perpendicular to the source wiring layers (in the horizontal direction in the drawing). A roughly rectangular space is surrounded by the source wiring layers, the common wiring layer 408, and the gate wiring layer. In this space, a pixel electrode layer and a common electrode layer of the liquid crystal display device are provided. A transistor 420 for driving the pixel electrode layer is provided at an upper left corner of the drawing. A plurality of pixel electrode layers and a plurality of transistors are arranged in matrix.

In the liquid crystal display device in FIGS. 2A and 2B, a first electrode layer 447 electrically connected to the transistor 420 serves as a pixel electrode layer, while a second electrode layer 446 electrically connected to the common wiring layer 408 serves as a common electrode layer. Note that a capacitor is formed with the first electrode layer and the common wiring layer. Although the common electrode layer can operate in a floating state (an electrically isolated state), the potential of the common electrode layer may be set to a fixed potential, preferably to a potential around a common potential (an intermediate potential of an image signal which is transmitted as data) at such a level as not to generate flickers.

A method can be used in which the gray scale is controlled by generating an electric field parallel to or substantially parallel to a substrate (i.e., in the lateral direction) to move liquid crystal molecules in a plane parallel to the substrate. For such a method, an electrode structure used in an IPS mode illustrated in FIGS. 2A and 2B and FIGS. 3A to 3C can be employed.

In a lateral electric field mode such as an IPS mode, a first electrode layer (e.g., a pixel electrode layer with which a voltage is controlled in each pixel) and a second electrode layer (e.g., a common electrode layer with which a common voltage is applied to all pixels), which has an opening pattern, are located below a liquid crystal composition. Therefore, the first electrode layer 447 and the second electrode layer 446, one of which is a pixel electrode layer and the other of which is a common electrode layer, are formed over a first substrate 441, and at least one of the first electrode layer and the second electrode layer is formed over an interlayer film. The first electrode layer 447 and the second electrode layer 446 have not a flat shape but various opening patterns including a bent portion or a branched comb-like portion. The first electrode layer 447 and the second electrode layer 446 do not have the same shape or do not overlap with each other in order to generate an electric field between the electrodes.

As the liquid crystal composition 444, the liquid crystal composition according to Embodiment 1, which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm, is used. The liquid crystal composition 444 may further contain an organic resin. In this embodiment, the liquid crystal composition 444 is subjected to polymer stabilization treatment, and the liquid crystal composition 444 is provided in a liquid crystal display device with a blue phase exhibited (with a blue phase shown).

With an electric field generated between the first electrode layer 447 as the pixel electrode layer and the second electrode layer 446 as the common electrode layer, liquid crystal of the liquid crystal composition 444 is controlled. An electric field in a lateral direction is generated for the liquid crystal, so that liquid crystal molecules can be controlled using the electric field. Since the liquid crystal molecules aligned to exhibit a blue phase can be controlled in a direction parallel to the substrate, a wide viewing angle is obtained.

FIGS. 3A to 3D illustrate other examples of the first electrode layer 447 and the second electrode layer 446. As illustrated in top views of FIGS. 3A to 3D, first electrode layers 447a to 447d and second electrode layers 446a to 446d are arranged alternately. In FIG. 3A, the first electrode layer 447a and the second electrode layer 446a have wavelike shapes with curves. In FIG. 3B, the first electrode layer 447b and the second electrode layer 446b have shapes with concentric circular openings. In FIG. 3C, the first electrode layer 447c and the second electrode layer 446c have comb-like shapes and partially overlap with each other. In FIG. 3D, the first electrode layer 447d and the second electrode layer 446d have comb-like shapes in which the electrode layers are engaged with each other. In the case where the first electrode layers 447a, 447b, and 447c overlap with the second electrode layers 446a, 446b, and 446c, respectively, as illustrated in FIGS. 3A to 3C, an insulating film is formed between the first electrode layer 447 and the second electrode layer 446 so that the first electrode layer 447 and the second electrode layer 446 are formed over different films.

Since the first electrode layer 447 and the second electrode layer 446 have opening patterns, they are illustrated as divided plural electrode layers in the cross-sectional view in FIG. 2B. The same applies to the other drawings of this specification.

The transistor 420 is an inverted staggered thin film transistor in which the gate electrode layer 401, a gate insulating layer 402, a semiconductor layer 403, and wiring layers 405a and 405b which function as a source electrode layer and a drain electrode layer are formed over the first substrate 441 which has an insulating surface.

There is no particular limitation on the structure of a transistor which can be used for a liquid crystal display device disclosed in this specification. For example, a staggered type or a planar type having a top-gate structure or a bottom-gate structure can be employed. The transistor may have a single-gate structure in which one channel formation region is formed, a double-gate structure in which two channel formation regions are formed, or a triple-gate structure in which three channel formation regions are formed. Alternatively, the transistor may have a dual gate structure including two gate electrode layers positioned over and below a channel region with a gate insulating layer interposed therebetween.

An insulating film 407 which is in contact with the semiconductor layer 403, and an insulating film 409 are provided to cover the transistor 420. The interlayer film 413 is stacked over the insulating film 409.

There is no particular limitation on the method for forming the interlayer film 413, and the following method can be employed depending on the material: spin coating, dip coating, spray coating, a droplet discharging method (such as an ink jet method, screen printing, or offset printing), roll coating, curtain coating, knife coating, or the like.

The first substrate 441 and the second substrate 442 which is a counter substrate are firmly attached to each other with a sealant with the liquid crystal composition 444 interposed therebetween. The liquid crystal composition 444 can be formed by a dispenser method (a dropping method), or an injection method by which liquid crystal is injected using capillary action or the like after the first substrate 441 is attached to the second substrate 442.

As the sealant, typically, a visible light curable resin, a UV curable resin, or a thermosetting resin is preferably used. Typically, an acrylic resin, an epoxy resin, an amine resin, or the like can be used. Further, a photopolymerization initiator (typically, a UV polymerization initiator), a thermosetting agent, a filler, or a coupling agent may be contained in the sealant.

In this embodiment, the liquid crystal composition 444 is subjected to polymer stabilization treatment; thus, as the liquid crystal composition 444, a liquid crystal composition is used, which is obtained by adding a photopolymerizable monomer and a photopolymerization initiator to the liquid crystal composition according to Embodiment 1, which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm.

After the space between the first substrate 441 and the second substrate 442 is filled with the liquid crystal composition, polymer stabilization treatment is performed by light irradiation, whereby the liquid crystal composition 444 is formed. The light has a wavelength with which the photopolymerizable monomer and the photopolymerization initiator which are contained in the liquid crystal composition used as the liquid crystal composition 444 react with each other. By such polymer stabilization treatment by light irradiation, the temperature range within which the liquid crystal composition 444 exhibits a blue phase can be broadened.

The liquid crystal composition according to this embodiment has strong twisting power, and in the liquid crystal composition 444 subjected to polymer stabilization treatment, the peak of the diffracted wavelength on the longest wavelength side in the reflectance spectrum can be a short wavelength (preferably, less than or equal to 450 nm, more preferably less than or equal to 420 nm). Thus, the transmittance of the liquid crystal composition in application of no voltage (at an applied voltage of 0 V) can be low, leading to a higher contrast ratio of a liquid crystal display device.

In the case where a photocurable resin such as a UV curable resin is used as a sealant and a liquid crystal composition is formed by a dropping method, for example, the sealant may be cured in the light irradiation step of the polymer stabilization treatment.

In this embodiment, a polarizing plate 443a is provided on the outer side (on the side opposite to the liquid crystal composition 444) of the first substrate 441, and a polarizing plate 443b is provided on the outer side (on the side opposite to the liquid crystal composition 444) of the second substrate 442. In addition to the polarizing plate, an optical film such as a retardation plate or an anti-reflection film may be provided. For example, circular polarization with the polarizing plate and the retardation plate may be used. Through the above process, a liquid crystal display device can be completed.

In the case of manufacturing a plurality of liquid crystal display devices using a large-sized substrate (a so-called multiple panel method), a division step can be performed before the polymer stabilization treatment or before provision of the polarizing plates. In consideration of the influence of the division step on the liquid crystal composition (such as alignment disorder due to force applied in the division step), it is preferable that the division step be performed after the attachment between the first substrate and the second substrate and before the polymer stabilization treatment.

Although not illustrated, a backlight, a sidelight, or the like may be used as a light source. Light from the light source is emitted from the side of the first substrate 441 which is an element substrate so as to pass through the second substrate 442 on the viewing side.

The first electrode layer 447 and the second electrode layer 446 can be formed using a light-transmitting conductive material such as indium oxide containing tungsten oxide, indium zinc oxide containing tungsten oxide, indium oxide containing titanium oxide, indium tin oxide containing titanium oxide, indium tin oxide, indium zinc oxide, indium tin oxide to which silicon oxide is added, or graphene.

The first electrode layer 447 and the second electrode layer 446 can be formed of one or more materials selected from metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and metal nitrides thereof.

The first electrode layer 447 and the second electrode layer 446 can be formed using a conductive composition including a conductive macromolecule (also referred to as a conductive polymer). The pixel electrode formed using the conductive composition preferably has a sheet resistance of less than or equal to 10000 ohms per square and a transmittance of greater than or equal to 70% at a wavelength of 550 nm. Further, the resistivity of the conductive macromolecule included in the conductive composition is preferably less than or equal to 0.1 Ω·cm.

As the conductive macromolecule, a so-called π-electron conjugated conductive macromolecule can be used. For example, polyaniline or a derivative thereof, polypyrrole or a derivative thereof, polythiophene or a derivative thereof, a copolymer of two or more kinds of them, and the like can be given.

An insulating film serving as a base film may be provided between the first substrate 441 and the gate electrode layer 401. The base film has a function of preventing diffusion of an impurity element from the first substrate 441, and can be formed to have a single-layer or layered structure using one or more of a silicon nitride film, a silicon oxide film, a silicon nitride oxide film, and a silicon oxynitride film. The gate electrode layer 401 can be formed to have a single-layer or layered structure using any of metal materials such as molybdenum, titanium, chromium, tantalum, tungsten, aluminum, copper, neodymium, and scandium, and an alloy material which contains any of these materials as its main component. By using a light-blocking conductive film as the gate electrode layer 401, light from a backlight (light emitted through the first substrate 441) can be prevented from entering the semiconductor layer 403.

For example, as a two-layer structure of the gate electrode layer 401, the following structures are preferable: a two-layer structure of an aluminum layer and a molybdenum layer stacked thereover, a two-layer structure of a copper layer and a molybdenum layer stacked thereover, a two-layer structure of a copper layer and a titanium nitride layer or a tantalum nitride layer stacked thereover, and a two-layer structure of a titanium nitride layer and a molybdenum layer. As a three-layer structure, a layered structure in which a tungsten layer or a tungsten nitride layer, an alloy layer of aluminum and silicon or an alloy layer of aluminum and titanium, and a titanium nitride layer or a titanium layer are stacked is preferable.

The gate insulating layer 402 can be formed to have a single-layer or layered structure using any of a silicon oxide layer, a silicon nitride layer, a silicon oxynitride layer, and a silicon nitride oxide layer by a plasma CVD method, a sputtering method, or the like. Alternatively, the gate insulating layer 402 can be formed using a silicon oxide layer by a CVD method using an organosilane gas. As an organosilane gas, a silicon-containing compound such as tetraethoxysilane (TEOS) (chemical formula: Si(OC₂H₅)₄), tetramethylsilane (TMS) (chemical formula: Si(CH₃)₄), tetramethylcyclotetrasiloxane (TMCTS), octamethylcyclotetrasiloxane (OMCTS), hexamethyldisilazane (HMDS), triethoxysilane (SiH(OC₂H₅)₃), or trisdimethylaminosilane (SiH(N(CH₃)₂)₃) can be used.

A material of the semiconductor layer 403 is not particularly limited and may be determined as appropriate in accordance with characteristics needed for the transistor 420. Examples of a material which can be used for the semiconductor layer 403 will be described.

The semiconductor layer 403 can be formed using the following material: an amorphous semiconductor manufactured by a sputtering method or a vapor-phase growth method using a semiconductor source gas typified by silane or germane; a polycrystalline semiconductor formed by crystallizing the amorphous semiconductor with the use of light energy or thermal energy; a microcrystalline semiconductor; or the like. The semiconductor layer can be formed by a sputtering method, an LPCVD method, a plasma CVD method, or the like.

A typical example of an amorphous semiconductor is hydrogenated amorphous silicon, while a typical example of a crystalline semiconductor is polysilicon. Examples of polysilicon (polycrystalline silicon) are as follows: so-called high-temperature polysilicon which contains polysilicon formed at a process temperature of 800° C. or higher as its main component, so-called low-temperature polysilicon which contains polysilicon formed at a process temperature of 600° C. or lower as its main component, and polysilicon obtained by crystallizing amorphous silicon with the use of an element that promotes crystallization, or the like. It is needless to say that a microcrystalline semiconductor or a semiconductor partly containing a crystal phase can be used as described above.

Further, an oxide semiconductor may be used. As the oxide semiconductor, an oxide of four metal elements such as an In—Sn—Ga—Zn—O-based oxide semiconductor; an oxide of three metal elements such as an In—Ga—Zn—O-based oxide semiconductor, an In—Sn—Zn—O-based oxide semiconductor, an In—Al—Zn—O-based oxide semiconductor, a Sn—Ga—Zn—O-based oxide semiconductor, an Al—Ga—Zn—O-based oxide semiconductor, or a Sn—Al—Zn—O-based oxide semiconductor; or an oxide of two metal elements such as an In—Zn—O-based oxide semiconductor, a Sn—Zn—O-based oxide semiconductor, an Al—Zn—O-based oxide semiconductor, a Zn—Mg—O-based oxide semiconductor, a Sn—Mg—O-based oxide semiconductor, an In—Mg—O-based oxide semiconductor, or In—Ga—O-based oxide semiconductor; an In—O-based oxide semiconductor; a Sn—O-based oxide semiconductor; or a Zn—O-based oxide semiconductor can be used. Further, SiO₂ may be contained in the above oxide semiconductor. Here, for example, an In—Ga—Zn—O-based oxide semiconductor is an oxide containing at least In, Ga, and Zn, and there is no particular limitation on the composition ratio thereof. Further, the In—Ga—Zn—O-based oxide semiconductor may contain an element other than In, Ga, and Zn.

For the oxide semiconductor layer, a thin film expressed by the chemical formula, InMO₃(ZnO)ₘ (m>0), can be used. Here, M represents one or more metal elements selected from Ga, Al, Mn, and Co. For example, M can be Ga, Ga and Al, Ga and Mn, or Ga and Co.

The oxide semiconductor layer contains an oxide including a crystal with c-axis alignment (also referred to as a C-Axis Aligned Crystal (CAAC)), which has neither a single crystal structure nor an amorphous structure.

In a process of forming the semiconductor layer and the wiring layer, an etching step is employed to process thin films into desired shapes. Dry etching or wet etching can be employed for the etching step.

As an etching apparatus used for the dry etching, an etching apparatus using a reactive ion etching method (an RIE method) or a dry etching apparatus using a high-density plasma source such as ECR (electron cyclotron resonance) or ICP (inductively coupled plasma) can be used. As a dry etching apparatus by which uniform electric discharge can be performed over a large area as compared to an ICP etching apparatus, there is an ECCP (enhanced capacitively coupled plasma) mode etching apparatus in which an upper electrode is grounded, a high-frequency power source at 13.56 MHz is connected to a lower electrode, and further a low-frequency power source at 3.2 MHz is connected to the lower electrode. This ECCP mode etching apparatus can be applied, for example, even when a substrate of the tenth generation with a side of larger than approximately 3 m is used.

In order to etch the films into desired shapes, the etching conditions (the amount of power applied to a coil-shaped electrode, the amount of power applied to an electrode on the substrate side, the temperature of the electrode on the substrate side, and the like) are adjusted as appropriate.

The etching conditions (such as an etchant, etching time, and temperature) are appropriately adjusted depending on the material so that the material can be etched to have a desired shape.

As a material of the wiring layers 405a and 405b serving as source and drain electrode layers, an element selected from Al, Cr, Ta, Ti, Mo, and W; an alloy containing any of the above elements as its component; an alloy film containing a combination of any of these elements; and the like can be given. Further, in the case where heat treatment is performed, the conductive film preferably has heat resistance against the heat treatment. Since the use of aluminum alone brings disadvantages such as low heat resistance and a tendency to corrosion, aluminum is used in combination with a conductive material having heat resistance. As the conductive material having heat resistance, which is combined with aluminum, it is possible to use an element selected from titanium (Ti), tantalum (Ta), tungsten (W), molybdenum (Mo), chromium (Cr), neodymium (Nd), and scandium (Sc); an alloy containing any of these elements as its component; an alloy containing a combination of any of these elements; or a nitride containing any of these elements as its component.

The gate insulating layer 402, the semiconductor layer 403, and the wiring layers 405a and 405b serving as source and drain electrode layers may be successively formed without being exposed to the air. Successive film formation without exposure to the air makes it possible to obtain each interface between stacked layers, which is not contaminated by atmospheric components or impurity elements floating in the air. Therefore, variation in characteristics of the transistor can be reduced.

Note that the semiconductor layer 403 is only partly etched so as to have a groove (a recessed portion).

As the insulating film 407 and the insulating film 409 which cover the transistor 420, an inorganic insulating film or an organic insulating film formed by a dry method or a wet method can be used. For example, it is possible to use a silicon nitride film, a silicon oxide film, a silicon oxynitride film, an aluminum oxide film, or a tantalum oxide film, which is formed by a CVD method, a sputtering method, or the like. Alternatively, an organic material such as polyimide, acrylic, benzocyclobutene, polyamide, or epoxy can be used. Other than such organic materials, it is possible to use a low-dielectric constant material (a low-k material), a siloxane-based resin, PSG (phosphosilicate glass), BPSG (borophosphosilicate glass), or the like. A gallium oxide film may be used as the insulating film 407.

Note that a siloxane-based resin is a resin formed using a siloxane material as a starting material and having a Si—O—Si bond. The siloxane-based resin may include as a substituent an organic group (e.g., an alkyl group or an aryl group) or a fluoro group. The organic group may include a fluoro group. A siloxane-based resin is applied by a coating method and baked; thus, the insulating film 407 can be formed.

Alternatively, the insulating film 407 and the insulating film 409 may be formed by stacking a plurality of insulating films formed using any of these materials. For example, a structure may be employed in which an organic resin film is stacked over an inorganic insulating film.

Further, with the use of a resist mask having regions with plural thicknesses (typically, two different thicknesses) which is formed using a multi-tone mask, the number of resist masks can be reduced, resulting in simplified process and lower cost.

As described above, higher contrast can be achieved with the use of a liquid crystal composition which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm. Accordingly, it is possible to provide a liquid crystal display device having a high level of visibility and high image quality.

The liquid crystal composition which exhibits a blue phase is capable of high-speed response. Thus, a high-performance liquid crystal display device can be realized.

This embodiment can be implemented in appropriate combination with any of the structures described in the other embodiments.

### Embodiment 3

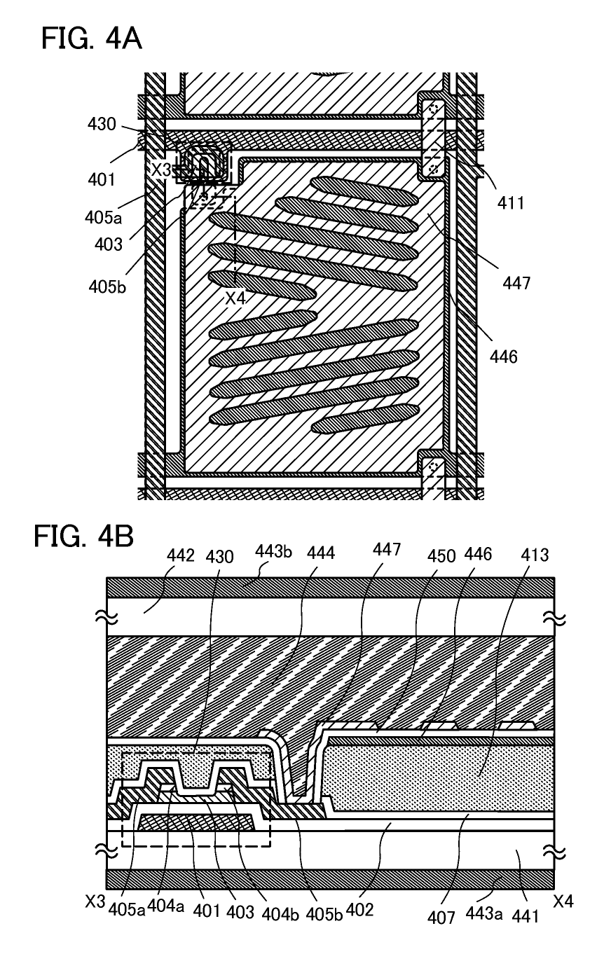

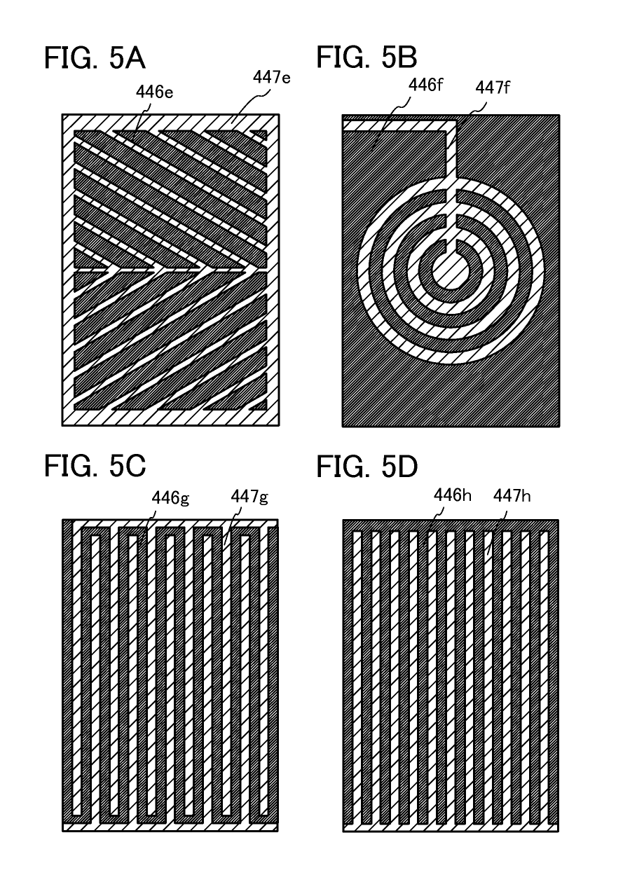

Another example of an active matrix liquid crystal display device to which the invention disclosed in this specification is applied will be described with reference to FIGS. 4A and 4B and FIGS. 5A to 5D.

FIG. 4A is a plan view of the liquid crystal display device and illustrates one pixel. FIG. 4B is a cross-sectional view along X3-X4 in FIG. 4A.

In FIG. 4A, a plurality of source wiring layers (including the wiring layer 405a) is arranged so as to be parallel to (extend in the longitudinal direction in the drawing) and apart from each other. A plurality of gate wiring layers (including the gate electrode layer 401) is arranged so as to be extended in a direction perpendicular to or substantially perpendicular to the source wiring layers (the horizontal direction in the drawing) and apart from each other. Common wiring layers (common electrode layers) are provided so as to be adjacent to the corresponding gate wiring layers and extended in a direction parallel to or substantially parallel to the gate wiring layers, that is, in a direction perpendicular to or substantially perpendicular to the source wiring layers (the horizontal direction in the drawing). A roughly rectangular space is surrounded by the source wiring layers, the common wiring layer (the common electrode layer), and the gate wiring layer. In this space, a pixel electrode layer and a common electrode layer of the liquid crystal display device are provided. A transistor 430 for driving the pixel electrode layer is provided at an upper left corner of the drawing. A plurality of pixel electrode layers and a plurality of transistors are arranged in matrix.

In the liquid crystal display device in FIGS. 4A and 4B, the first electrode layer 447 electrically connected to the transistor 430 serves as a pixel electrode layer, while the second electrode layer 446 electrically connected to the common wiring layer serves as a common electrode layer. As illustrated in FIGS. 4A and 4B, the second electrode layer 446 also serves as the common wiring layer in the pixel; thus, adjacent pixels are electrically connected to each other with a common electrode layer 411. Note that a capacitor is formed with the pixel electrode layer and the common electrode layer. Although the common electrode layer can operate in a floating state (an electrically isolated state), the potential of the common electrode layer may be set to a fixed potential, preferably to a potential around a common potential (an intermediate potential of an image signal which is transmitted as data) at such a level as not to generate flickers.

A method can be used in which the gray scale is controlled by generating an electric field parallel to or substantially parallel to a substrate (i.e., in the lateral direction) to move liquid crystal molecules in a plane parallel to the substrate. For such a method, an electrode structure used in an FFS mode illustrated in FIGS. 4A and 4B and FIGS. 5A to 5D can be employed.

In a lateral electric field mode such as an FFS mode, a first electrode layer (e.g., a pixel electrode layer with which a voltage is controlled in each pixel) having an opening pattern is located below a liquid crystal composition, and further, a second electrode layer (e.g., a common electrode layer with which a common voltage is applied to all pixels) having a flat shape is located below the opening pattern. Therefore, the first electrode layer 447 and the second electrode layer 446, one of which is a pixel electrode layer and the other of which is a common electrode layer, are formed over the first substrate 441, and the pixel electrode layer and the common electrode layer are stacked with an insulating film (or an interlayer insulating film) interposed therebetween. One of the pixel electrode layer and the common electrode layer is formed below the other and has a flat shape, whereas the other is formed above the one and has various opening patterns including a bent portion or a branched comb-like portion. The first electrode layer 447 and the second electrode layer 446 do not have the same shape and do not overlap with each other in order to generate an electric field between the electrodes.

In this embodiment, an electrode layer having an opening pattern (slit) is used as the first electrode layer 447 which is a pixel electrode layer, and an electrode layer having a flat shape is used as the second electrode layer 446 which is a common electrode layer.

In order to generate an electric field between the first electrode layer 447 and the second electrode layer 446, the electrode layers are located such that the second electrode layer 446 having a flat shape and the opening pattern (slit) of the first electrode layer 447 overlap with each other.

As the liquid crystal composition 444, the liquid crystal composition according to Embodiment 1, which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm, is used.

With an electric field generated between the first electrode layer 447 and the second electrode layer 446, liquid crystal of the liquid crystal composition 444 is controlled. An electric field in a lateral direction is generated for the liquid crystal, so that liquid crystal molecules can be controlled using the electric field. Since the liquid crystal molecules aligned to exhibit a blue phase can be controlled in a direction parallel to the substrate, a wide viewing angle is obtained.

In the liquid crystal composition according to Embodiment 1, the peak of the diffracted wavelength on the longest wavelength side in the reflectance spectrum is less than or equal to 450 nm, preferably less than or equal to 420 nm, and the twisting power is strong. When the twisting power of the liquid crystal composition is strong, the transmittance of the liquid crystal composition in application of no voltage (at an applied voltage of 0 V) can be low, leading to a higher contrast of a liquid crystal display device including the liquid crystal composition as the liquid crystal composition 444.

FIGS. 5A to 5D illustrate examples of the first electrode layer 447 and the second electrode layer 446. As illustrated in FIGS. 5A to 5D, first electrode layers 447e to 447h and second electrode layers 446e to 446h are disposed so as to overlap with each other, and insulating films are formed between the first electrode layers 447e to 447h and the second electrode layers 446e to 446h, so that the first electrode layers 447e to 447h and the second electrode layers 446e to 446h are formed over different films.

As illustrated in top views in FIGS. 5A to 5D, the first electrode layers 447e to 447h are formed in various shapes over the second electrode layers 446e to 446h. In FIG. 5A, the first electrode layers 447e is formed in a V-like shape over the second electrode layer 446e; in FIG. 5B, the first electrode layer 447f is formed in a concentric circular shape over the second electrode layer 446f; in FIG. 5C, the first electrode layer 447g is formed in a comb-like shape over the second electrode layer 446g and the electrode layers 447g and 446g are engaged with each other; and in FIG. 5D, the first electrode layer 447h is formed in a comb-like shape over the second electrode layer 446h.

The transistor 430 is an inverted staggered thin film transistor in which the gate electrode layer 401, the gate insulating layer 402, the semiconductor layer 403, source and drain regions 404a and 404b, and the wiring layers 405a and 405b which function as a source electrode layer and a drain electrode layer are formed over the first substrate 441 which has an insulating surface. The first electrode layer 447 is formed in the same layer as the gate electrode layer 401 over the first substrate 441 and is an electrode layer having a flat shape in the pixel.

As in the transistor 430, the source and drain regions 404a and 404b may be provided between the semiconductor layer 403 and the wiring layers 405a and 405b which function as a source electrode layer and a drain electrode layer. The source and drain regions 404a and 404b may be formed using a semiconductor layer whose resistance is lower than that of the semiconductor layer 403, or the like.

The insulating film 407 which covers the transistor 430 and is in contact with the semiconductor layer 403 is provided. The interlayer film 413 is provided over the insulating film 407, the second electrode layer 446 in a flat shape is provided in a pixel over the interlayer film 413, and the first electrode layer 447 having an opening pattern is formed over the second electrode layer 446 with the insulating film 450 interposed therebetween. Thus, the first electrode layer 447 and the second electrode layer 446 are provided so as to overlap with each other with the insulating film 450 interposed therebetween.

Note that in this embodiment, with the use of light-transmitting electrode layers for the first electrode layer 447 and the second electrode layer 446, a transmissive liquid crystal display device can be obtained. Alternatively, with the use of a reflective electrode layer for the second electrode layer 446 in a flat shape, a reflective liquid crystal display device can be obtained.

As described above, higher contrast can be achieved with the use of a liquid crystal composition which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm. Accordingly, it is possible to provide a liquid crystal display device having a high level of visibility and high image quality.

The liquid crystal composition which exhibits a blue phase is capable of high-speed response. Thus, a high-performance liquid crystal display device can be realized.

This embodiment can be implemented in appropriate combination with any of the structures described in the other embodiments.

### Embodiment 4

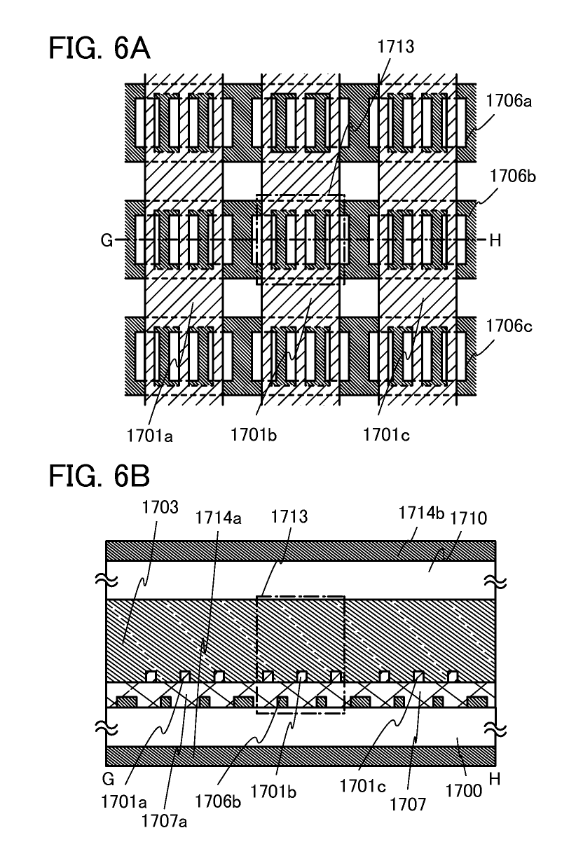

The invention disclosed in this specification can be applied to both a passive matrix liquid crystal display device and an active matrix liquid crystal display device. An example of a passive matrix liquid crystal display device will be described with reference to FIGS. 6A and 6B. FIG. 6A is a top view of a liquid crystal display device, and FIG. 6B is a cross-sectional view along G-H in FIG. 6A. In FIG. 6A, a liquid crystal composition 1703, a substrate 1710 which functions as a counter substrate, a polarizing plate 1714, and the like are omitted and not illustrated; however, they are provided as illustrated in FIG. 6B.

FIGS. 6A and 6B illustrate the liquid crystal display device in which a substrate 1700 that is provided with the polarizing plate 1714a and the substrate 1710 that is provided with the polarizing plate 1714b are positioned so as to face each other with the liquid crystal composition 1703 interposed therebetween. Common electrode layers 1706a, 1706b, and 1706c, an insulating film 1707, and pixel electrode layers 1701a, 1701b, and 1701c are provided between the substrate 1700 and the liquid crystal composition 1703.

The pixel electrode layers 1701a, 1701b, and 1701c and the common electrode layers 1706a, 1706b, and 1706c each have a shape with an opening pattern which includes a rectangular opening (slit) in a pixel region of a liquid crystal element 1713.

As the liquid crystal composition 1703, a liquid crystal composition described in Embodiment 1 is used, which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm. Further, the liquid crystal composition 1703 may contain an organic resin.

With an electric field generated between the pixel electrode layers 1701a, 1701b, and 1701c and the common electrode layers 1706a, 1706b, and 1706c, liquid crystal of the liquid crystal composition 1703 is controlled. An electric field in the lateral direction is generated for the liquid crystal, so that liquid crystal molecules can be controlled using the electric field. Since the liquid crystal molecules aligned to exhibit a blue phase can be controlled in the direction parallel to the substrate, a wide viewing angle is obtained.

In the liquid crystal composition according to Embodiment 1, the peak of the diffracted wavelength on the longest wavelength side in the reflectance spectrum is less than or equal to 450 nm, preferably less than or equal to 420 nm, and the twisting power is strong. When the twisting power of the liquid crystal composition is strong, the transmittance of the liquid crystal composition in application of no voltage (at an applied voltage of 0 V) can be low, leading to a higher contrast of a liquid crystal display device including the liquid crystal composition as the liquid crystal composition 1703.

In addition, a coloring layer which functions as a color filter may be provided, and the color filter may be provided on the inner side of the substrate 1700 or/and the substrate 1710 with respect to the liquid crystal composition 1703, between the substrate 1710 and the polarizing plate 1714b, or between the substrate 1700 and the polarizing plate 1714a.

When the liquid crystal display device performs full-color display, the color filter may be made of materials which exhibit red (R), green (G), and blue (B). When the liquid crystal display device performs single-color display, the coloring layer may be omitted or may be formed of a material which exhibits at least one color. Note that the color filter is not always provided in the case where light-emitting diodes (LEDs) of RGB, or the like are arranged in a backlight unit and a successive additive color mixing method (a field sequential method) in which color display is performed by time division is employed.

The pixel electrode layers 1701a, 1701b, and 1701c and the common electrode layers 1706a, 1706b and 1706c may be formed using one or more of the following: indium tin oxide (ITO), a conductive material in which zinc oxide (ZnO) is mixed into indium oxide, a conductive material in which silicon oxide (SiO₂) is mixed into indium oxide, organoindium, organotin, indium oxide containing tungsten oxide, indium zinc oxide containing tungsten oxide, indium oxide containing titanium oxide, and indium tin oxide containing titanium oxide; graphene; metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and metal nitrides thereof.

As described above, higher contrast can be achieved with the use of a liquid crystal composition which contains a chiral agent and liquid crystal containing a compound having three electron-withdrawing groups as end groups of a structure where a plurality of rings including at least one aromatic ring is linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm. Accordingly, it is possible to provide a liquid crystal display device having a high level of visibility and high image quality.

The liquid crystal composition which exhibits a blue phase is capable of high-speed response. Thus, a high-performance liquid crystal display device can be realized.

This embodiment can be implemented in appropriate combination with any of the structures described in the other embodiments.

### Embodiment 5

The liquid crystal display device illustrated in any of Embodiments 1 to 4 can be provided with a light-blocking layer (a black matrix). Note that components similar to those in Embodiments 1 to 4 can be formed using similar materials and similar manufacturing methods, and detailed description of the same portions and portions which have similar functions is omitted.

The light-blocking layer may be provided on the inner side of a pair of substrates firmly attached to each other with a liquid crystal composition interposed therebetween or may be provided on the outer side of the substrates (on the side opposite to the liquid crystal composition).

In the case where a light-blocking layer is provided on the inner side of a pair of substrates in a liquid crystal display device, the light-blocking layer can be formed on the side of an element substrate provided with a pixel electrode layer, or on the counter substrate side. The light-blocking layer can be additionally provided; alternatively, in the case of an active matrix liquid crystal display device in Embodiment 2, Embodiment 3, or the like, the light-blocking layer can be formed as an interlayer film provided on an element substrate. In the liquid crystal display device of Embodiment 2 illustrated in FIGS. 4A and 4B, for example, a light-blocking layer can be formed as part of the interlayer film 413.

The light-blocking layer is formed using a light-blocking material that reflects or absorbs light. For example, a black organic resin can be used, which can be formed by mixing a black resin of a pigment material, carbon black, titanium black, or the like into a resin material such as photosensitive or non-photosensitive polyimide. Alternatively, a light-blocking metal film can be used, which may be formed using chromium, molybdenum, nickel, titanium, cobalt, copper, tungsten, aluminum, or the like, for example.

There is no particular limitation on the method for forming the light-blocking layer, and a dry method such as an evaporation method, a sputtering method, or a CVD method or a wet method such as spin coating, dip coating, spray coating, a droplet discharging method (e.g., ink jetting, screen printing, or offset printing), may be used depending on the material. As needed, an etching method (dry etching or wet etching) may be employed to form a desired pattern.

In the case where the light-blocking layer is formed as part of the interlayer film 413, it is preferably formed using a black organic resin.

In the case where the light-blocking layer is formed directly on the element substrate side as part of the interlayer film, the problem of misalignment between the light-blocking layer and a pixel region does not occur, whereby the formation region can be controlled more precisely even when a pixel has a minute pattern.

When the liquid crystal display device has a structure in which the light-blocking layer is formed over the element substrate, light emitted from the counter substrate side is not absorbed or blocked by the light-blocking composition in light irradiation for polymer stabilization treatment; thus, the entire liquid crystal composition can be uniformly irradiated with light. Thus, alignment disorder of liquid crystal due to nonuniform photopolymerization, display unevenness due to the alignment disorder, and the like can be prevented.

In the liquid crystal display device, the light-blocking layer can be provided in an area overlapping with a semiconductor layer of a transistor or a contact hole, or between pixels.

The light-blocking layer provided in this manner can block light entering the semiconductor layer of the transistor; consequently, electric characteristics of the transistor can be prevented from varying due to incident light and can be stabilized. Further, the light-blocking layer prevents light leakage to an adjacent pixel, and reduces display unevenness caused by light leakage or the like due to an alignment defect of liquid crystal which occurs easily over a contact hole. As a result, higher definition and higher reliability of the liquid crystal display device can be achieved.

This embodiment can be implemented in appropriate combination with any of the structures described in the other embodiments.

### Embodiment 6

This embodiment shows an example of a liquid crystal display device performing color display. The liquid crystal display device described in any of Embodiments 1 to 5 can be provided with a color filter to perform color display. Note that components similar to those in Embodiments 1 to 5 can be formed using similar materials and similar manufacturing methods, and detailed description of the same portions and portions which have similar functions is omitted.

In the case where a liquid crystal display device performs full-color display, a color filter may be made of materials which exhibit red (R), green (G), and blue (B). In the case of mono-color display other than monochrome display, a color filter may be made of a material which exhibits at least one color.

Specifically, the liquid crystal display device is provided with a coloring layer serving as a color filter layer. The light-blocking layer may be provided on the inner side of a pair of substrates firmly attached to each other with a liquid crystal composition interposed therebetween or may be provided on the outer side of the substrates (on the side opposite to the liquid crystal composition).

First, description will be made of the case where a color filter layer is provided on the inner side of a pair of substrates in a liquid crystal display device. The color filter layer can be formed on the side of an element substrate provided with a pixel electrode layer, or on the counter substrate side. The color filter layer can be additionally provided; alternatively, in the case of an active matrix liquid crystal display device described in Embodiment 2 or 3, the color filter layer can be formed as an interlayer film provided on an element substrate. In the case of the liquid crystal display device of Embodiment 2 illustrated in FIGS. 2A and 2B, for example, a chromatic-color light-transmitting resin layer serving as a color filter layer can be used as the interlayer film 413.

In the case where the interlayer film is formed directly on the element substrate side as the color filter layer, the problem of misalignment between the color filter layer and a pixel region does not occur, whereby the formation region can be controlled more precisely even when a pixel has a minute pattern. In addition, the same insulating layer serves as the interlayer film and the color filter layer, which brings advantages of process simplification and cost reduction.

When the liquid crystal display device has a structure in which the color filter layer is formed over the element substrate, light emitted from the counter substrate side is not absorbed by the light-blocking composition in light irradiation for polymer stabilization treatment; thus, the entire liquid crystal composition can be uniformly irradiated with light. Thus, alignment disorder of liquid crystal due to nonuniform photopolymerization, display unevenness due to the alignment disorder, and the like can be prevented.

As the chromatic-color light-transmitting resin that can be used for the color filter layer, a photosensitive organic resin or a non-photosensitive organic resin can be used. Use of the photosensitive organic resin layer makes it possible to reduce the number of resist masks; thus, the process is simplified, which is preferable.

Chromatic colors are colors except achromatic colors such as black, gray, and white. The coloring layer is formed of a material which only transmits light colored with chromatic color in order to function as the color filter. As chromatic color, red, green, blue, or the like can be used. Alternatively, cyan, magenta, yellow, or the like may be used. “Transmitting only the chromatic color light” means that light transmitted through the coloring layer has a peak at the wavelength of the chromatic color light.

The thickness of the color filter layer may be controlled as appropriate in consideration of the relation between the concentration of the coloring material to be included and the transmittance of light.

In the case where the thickness of the chromatic-color light-transmitting resin layer varies depending on the color or in the case where there is unevenness due to a light-blocking layer or a transistor, an insulating layer which transmits light in the visible wavelength range (a so-called colorless and transparent insulating layer) may be stacked for planarization. The improved planarization allows favorable coverage with a pixel electrode layer or the like formed over the color filter layer, and a uniform gap (thickness) of a liquid crystal composition, whereby the visibility of the liquid crystal display device is increased and higher image quality can be achieved.

In the case where the color filter is provided on the outer side of a substrate, the color filter can be attached to the substrate with an adhesive layer or the like. In the case where the color filter is provided on the outer side of a counter substrate, polymer stabilization of a blue phase is performed by light irradiation, and then the color filter is provided on the outer side of the counter substrate.

As a light source, a backlight, a sidelight, or the like may be used. Light from the light source is emitted to the viewing side through the color filter, so that color display can be performed. As a light source, a cold cathode tube or a white light-emitting diode can be used. In addition, an optical member such as a reflection plate, a diffusion plate, a polarizing plate, or a retardation plate may be provided.

Thus, a color display function can be added to the liquid crystal display device with high contrast and low power consumption.

This embodiment can be implemented in appropriate combination with any of the structures described in the other embodiments.

### Embodiment 7

A liquid crystal display device having a display function can be manufactured by manufacturing transistors and using the transistors for a pixel portion and further for a driver circuit. When part or whole of the driver circuit is formed over the same substrate as the pixel portion with the use of the transistors, a system-on-panel can be obtained.

The liquid crystal display device includes a liquid crystal element (also referred to as a liquid crystal display element) as a display element.

Further, a liquid crystal display device includes a panel in which a display element is sealed, and a module in which an IC or the like including a controller is mounted to the panel. One embodiment of the present invention also relates to an element substrate, which corresponds to one mode in which the display element has not been completed in a manufacturing process of the liquid crystal display device, and the element substrate is provided with a means for supplying current to the display element in each of a plurality of pixels. Specifically, the element substrate may be in a state where it is provided only with a pixel electrode of the display element, in a state where a conductive film to be a pixel electrode has been formed and the conductive film has not yet been etched to form the pixel electrode, or in any other state.

Note that a liquid crystal display device in this specification means an image display device, a display device, or a light source (including a lighting device). Further, the liquid crystal display device includes any of the following modules in its category: a module to which a connector such as a flexible printed circuit (FPC), tape automated bonding (TAB) tape, or a tape carrier package (TCP) is attached; a module having TAB tape or a TCP which is provided with a printed wiring board at the end thereof; and a module having an integrated circuit (IC) directly mounted on a display element by a chip on glass (COG) method.

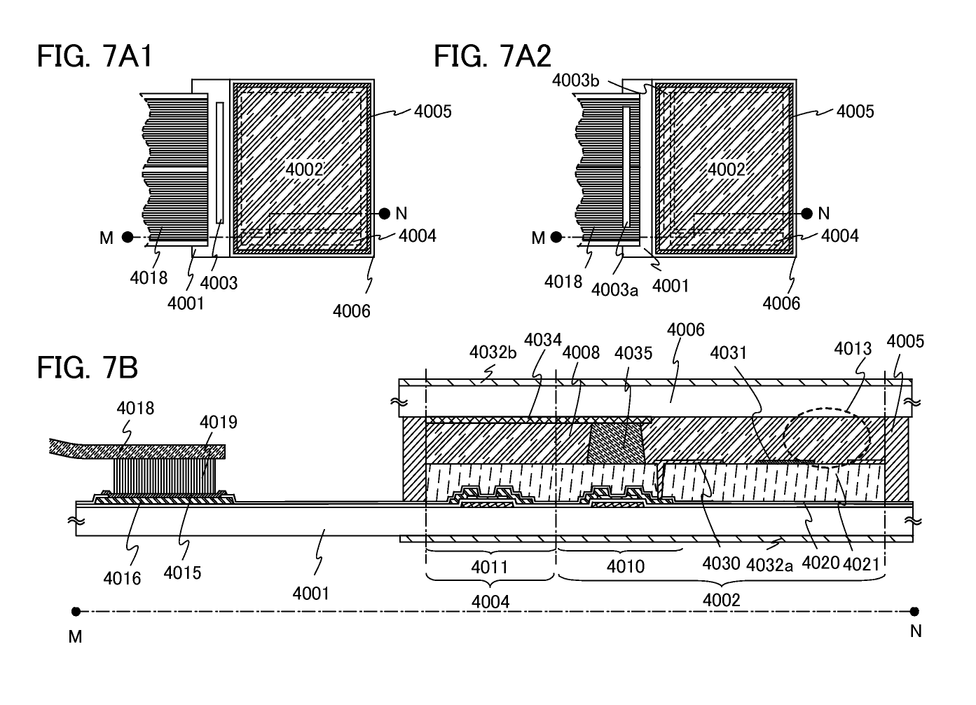

The appearance and the cross section of a liquid crystal display panel, which is one embodiment of the liquid crystal display device, will be described with reference to FIGS. 7A1, 7A2, and 7B. FIGS. 7A1 and 7A2 are top views of a panel in which transistors 4010 and 4011 and a liquid crystal element 4013 are sealed between a first substrate 4001 and a second substrate 4006 with a sealant 4005. FIG. 7B is a cross-sectional view along M-N in FIGS. 7A1 and 7A2.

The sealant 4005 is provided so as to surround a pixel portion 4002 and a scan line driver circuit 4004 which are provided over the first substrate 4001. The second substrate 4006 is provided over the pixel portion 4002 and the scan line driver circuit 4004. Thus, the pixel portion 4002 and the scan line driver circuit 4004 are sealed together with a liquid crystal composition 4008, by the first substrate 4001, the sealant 4005, and the second substrate 4006.

In FIG. 7A1, a signal line driver circuit 4003 that is formed using a single crystal semiconductor film or a polycrystalline semiconductor film over a substrate separately prepared is mounted in a region that is different from the region surrounded by the sealant 4005 over the first substrate 4001. FIG. 7A2 illustrates an example in which part of a signal line driver circuit is formed over the first substrate 4001 with the use of a transistor. A signal line driver circuit 4003b is formed over the first substrate 4001 and a signal line driver circuit 4003a that is formed using a single crystal semiconductor film or a polycrystalline semiconductor film over a substrate separately prepared is mounted on the first substrate 4001.

Note that there is no particular limitation on the connection method of a driver circuit which is separately formed, and a COG method, a wire bonding method, a TAB method, or the like can be used. FIG. 7A1 illustrates an example of mounting the signal line driver circuit 4003 by a COG method, and FIG. 7A2 illustrates an example of mounting the signal line driver circuit 4003 by a TAB method.

The pixel portion 4002 and the scan line driver circuit 4004 which are provided over the first substrate 4001 include a plurality of transistors. FIG. 7B illustrates the transistor 4010 included in the pixel portion 4002 and the transistor 4011 included in the scan line driver circuit 4004 as an example. An insulating layer 4020 and an interlayer film 4021 are provided over the transistors 4010 and 4011.

The transistor described in Embodiment 2 or 3 can be used as the transistors 4010 and 4011.

Further, a conductive layer may be provided over the interlayer film 4021 or the insulating layer 4020 so as to overlap with a channel formation region of a semiconductor layer of the transistor 4011 for the driver circuit. The conductive layer may have the same potential as or a potential different from that of a gate electrode layer of the transistor 4011 and can function as a second gate electrode layer. Further, the potential of the conductive layer may be GND or 0 V, or the conductive layer may be in a floating state.

A pixel electrode layer 4030 and a common electrode layer 4031 are provided over the interlayer film 4021, and the pixel electrode layer 4030 is electrically connected to the transistor 4010. The liquid crystal element 4013 includes the pixel electrode layer 4030, the common electrode layer 4031, and the liquid crystal composition 4008. Note that a polarizing plate 4032a and a polarizing plate 4032b are provided on the outer sides of the first substrate 4001 and the second substrate 4006, respectively. In this embodiment, the pixel electrode layer 4030 and the common electrode layer 4031 have an opening pattern as illustrated in FIGS. 2A and 2B of Embodiment 2; however, one of the pixel electrode layer and the common electrode layer may be an electrode layer in a flat shape as in Embodiment 3. The structures of the pixel electrode layer and the common electrode layer, which are described in any of Embodiments 2 to 4 can be used for the pixel electrode layer and the common electrode layer.

As the liquid crystal composition 4008, a liquid crystal composition according to Embodiment 1, which contains a chiral agent and liquid crystal containing a compound having three electron-withdrawing groups as end groups of a structure where a plurality of rings including at least one aromatic ring are linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm, is used. Further, the liquid crystal composition provided as the liquid crystal composition 4008 may contain an organic resin.

With an electric field generated between the pixel electrode layer 4030 and the common electrode layer 4031, liquid crystal of the liquid crystal composition 4008 is controlled. An electric field in the lateral direction is generated for the liquid crystal, so that liquid crystal molecules can be controlled using the electric field. Since the liquid crystal molecules aligned so that a blue phase is exhibited can be controlled in the direction parallel to the substrate, a wide viewing angle is obtained.

In the liquid crystal composition according to Embodiment 1, the peak of the diffracted wavelength on the longest wavelength side in the reflectance spectrum is less than or equal to 450 nm, preferably less than or equal to 420 nm, and the twisting power is strong. When the twisting power of the liquid crystal composition is strong, the transmittance of the liquid crystal composition in application of no voltage (at an applied voltage of 0 V) can be low, leading to a higher contrast of a liquid crystal display device including the liquid crystal composition as the liquid crystal composition 4008.

As the first substrate 4001 and the second substrate 4006, glass, plastic, or the like having a light-transmitting property can be used. As plastic, a fiberglass-reinforced plastics (FRP) plate, a polyvinyl fluoride (PVF) film, a polyester film, or an acrylic resin film can be used. Alternatively, a sheet with a structure in which an aluminum foil is sandwiched between PVF films or polyester films can be used.

A columnar spacer denoted by reference numeral 4035 is obtained by selective etching of an insulating film and is provided in order to control the thickness (a cell gap) of the liquid crystal composition 4008. Alternatively, a spherical spacer may be used. In the liquid crystal display device including the liquid crystal composition 4008, the cell gap which is the thickness of the liquid crystal composition is preferably greater than or equal to 1 μm and less than or equal to 20 μm. In this specification, the thickness of a cell gap refers to the length (film thickness) of a thickest part of a liquid crystal composition.

Although FIGS. 7A1, 7A2, and 7B illustrate examples of transmissive liquid crystal display devices, one embodiment of the present invention can also be applied to a transflective liquid crystal display device and a reflective liquid crystal display device.

FIGS. 7A1, 7A2, and 7B illustrate examples of liquid crystal display devices in which a polarizing plate is provided on the outer side (the viewing side) of a substrate; however, the polarizing plate may be provided on the inner side of the substrate. The position of the polarizing plate may be determined as appropriate depending on the material of the polarizing plate and conditions of the manufacturing process. Furthermore, a light-blocking layer serving as a black matrix may be provided.

A color filter layer or a light-blocking layer may be formed as part of the interlayer film 4021. In FIGS. 7A1, 7A2, and 7B, a light-blocking layer 4034 is provided on the second substrate 4006 side so as to cover the transistors 4010 and 4011. By providing the light-blocking layer 4034, the contrast can be more increased and the transistors can be more stabilized.

The thin film transistors may be, but is not necessarily, covered with the insulating layer 4020 which functions as a protective film of the thin film transistors.

Note that the protective film is provided to prevent entry of contamination impurities such as an organic substance, metal, and moisture floating in the air and is preferably a dense film. The protective film may be formed by a sputtering method to have a single-layer structure or a layered structure including any of a silicon oxide film, a silicon nitride film, a silicon oxynitride film, a silicon nitride oxide film, an aluminum oxide film, an aluminum nitride film, an aluminum oxynitride film, and an aluminum nitride oxide film.

Further, in the case of further forming a light-transmitting insulating layer as a planarizing insulating film, the light-transmitting insulating layer can be formed using an organic material having heat resistance, such as polyimide, acrylic, benzocyclobutene, polyamide, or epoxy. Other than such organic materials, it is possible to use a low-dielectric constant material (a low-k material), a siloxane-based resin, PSG (phosphosilicate glass), BPSG (borophosphosilicate glass), or the like. The insulating layer may be formed by stacking a plurality of insulating films formed using any of these materials.

There is no particular limitation on the method for forming the interlayer layer, and the following method can be employed depending on the material: spin coating, dip coating, spray coating, a droplet discharging method (such as an ink-jet method, screen printing, or offset printing), roll coating, curtain coating, knife coating, or the like.

The pixel electrode layer 4030 and the common electrode layer 4031 can be formed using a light-transmitting conductive material such as indium oxide containing tungsten oxide, indium zinc oxide containing tungsten oxide, indium oxide containing titanium oxide, indium tin oxide containing titanium oxide, indium tin oxide, indium zinc oxide, indium tin oxide to which silicon oxide is added, or graphene.

The pixel electrode layer 4030 and the common electrode layer 4031 can be formed of one or more materials selected from metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and metal nitrides thereof.

The pixel electrode layer 4030 and the common electrode layer 4031 can be formed using a conductive composition including a conductive macromolecule (also referred to as a conductive polymer).

Further, a variety of signals and potentials are supplied to the signal line driver circuit 4003 which is formed separately, the scan line driver circuit 4004, or the pixel portion 4002 from an FPC 4018.

Further, since the transistor is easily broken by static electricity or the like, a protective circuit for protecting the driver circuits is preferably provided over the same substrate as a gate line or a source line. The protective circuit is preferably formed using a nonlinear element.

In FIGS. 7A1, 7A2, and 7B, a connection terminal electrode 4015 is formed using the same conductive film as the pixel electrode layer 4030, and a terminal electrode 4016 is formed using the same conductive film as source electrode layers and drain electrode layers of the transistors 4010 and 4011.

The connection terminal electrode 4015 is electrically connected to a terminal of the FPC 4018 through an anisotropic conductive film 4019.

Although FIG. 7A2 illustrate an example in which the signal line driver circuit 4003 is formed separately and mounted on the first substrate 4001, one embodiment of the present invention is not limited to this structure. The scan line driver circuit may be separately formed and then mounted, or only part of the signal line driver circuit or part of the scan line driver circuit may be separately formed and then mounted.

As described above, higher contrast can be achieved with the use of a liquid crystal composition which contains a chiral agent and liquid crystal containing a compound having three electron-withdrawing groups as end groups of a structure where a plurality of rings including at least one aromatic ring are linked to each other directly or with a linking group laid therebetween, and which exhibits a blue phase, in which the peak of the diffracted wavelength on the longest wavelength side in the reflectance spectrum is less than or equal to 450 nm, preferably less than or equal to 420 nm. Accordingly, it is possible to provide a liquid crystal display device having a high level of visibility and high image quality.

The liquid crystal composition which exhibits a blue phase is capable of high-speed response. Thus, a high-performance liquid crystal display device can be realized.

This embodiment can be implemented in appropriate combination with any of the structures described in the other embodiments.

### Embodiment 8

A liquid crystal display device disclosed in this specification can be applied to a variety of electronic appliances (including game machines). Examples of electronic devices are a television set (also referred to as a television or a television receiver), a monitor of a computer or the like, cameras such as a digital camera and a digital video camera, a digital photo frame, a mobile phone handset (also referred to as a mobile phone or a mobile phone device), a portable game machine, a portable information terminal, an audio reproducing device, a large-sized game machine such as a pachinko machine, and the like.

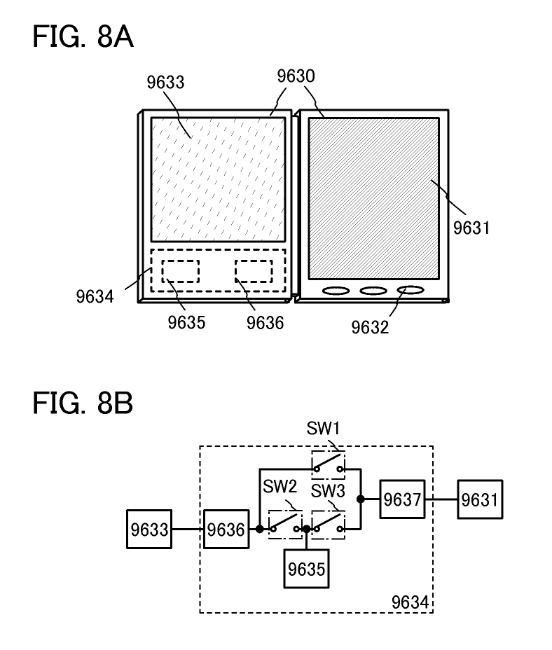

FIG. 8A illustrates an electronic book reader (also referred to as an e-book reader) which can include housings 9630, a display portion 9631, operation keys 9632, a solar cell 9633, and a charge and discharge control circuit 9634. The electronic book reader illustrated in FIG. 8A has a function of displaying various kinds of data (e.g., a still image, a moving image, and a text image) on the display portion, a function of displaying a calendar, a date, the time, or the like on the display portion, a function of operating or editing the data displayed on the display portion, a function of controlling processing by various kinds of software (programs), and the like. Note that in FIG. 8A, the charge and discharge control circuit 9634 has a battery 9635 and a DCDC converter (hereinafter, abbreviated as a converter) 9636. When the liquid crystal display device described in any of Embodiments 1 to 7 is used for the display portion 9631, the electronic book reader can have high contrast, a high level of visibility, and low power consumption.

In the case where a transflective liquid crystal display device or a reflective liquid crystal display device is used as the display portion 9631, use under a relatively bright condition is assumed; therefore, the structure illustrated in FIG. 8A is preferable because power generation by the solar cell 9633 and charge with the battery 9635 can be effectively performed. Since the solar cell 9633 can be provided in a space (a surface or a rear surface) of the housings 9630 as appropriate, the battery 9635 can be efficiently charged, which is preferable. When a lithium ion battery is used as the battery 9635, there is an advantage of downsizing or the like.

The structure and the operation of the charge and discharge control circuit 9634 illustrated in FIG. 8A will be described with reference to a block diagram in FIG. 8B. The solar cell 9633, the battery 9635, the converter 9636, a converter 9637, switches SW1 to SW3, and the display portion 9631 are shown in FIG. 8B, and the battery 9635, the converter 9636, the converter 9637, and the switches SW1 to SW3 are included in the charge and discharge control circuit 9634.

First, an example of operation in the case where power is generated by the solar cell 9633 using external light is described. The voltage of power generated by the solar cell is raised or lowered by the converter 9636 to a voltage for charging the battery 9635. Then, when the power from the solar cell 9633 is used for the operation of the display portion 9631, the switch SW1 is turned on and the voltage of the power is raised or lowered by the converter 9637 to a voltage needed for the display portion 9631. In addition, when display on the display portion 9631 is not performed, for example, the switch SW1 is turned off and the switch SW2 is turned on so that the battery 9635 is charged.

Next, operation in the case where power is not generated by the solar cell 9633 using external light is described. The voltage of power stored in the battery 9635 is raised or lowered by the converter 9637 by turning on the switch SW3. Then, power from the battery 9635 is used for the operation of the display portion 9631.

Note that although the solar cell 9633 is described as an example of a means for charge, the battery 9635 may be charged with another means. In addition, a combination of the solar cell 9633 and another means for charge may be used.

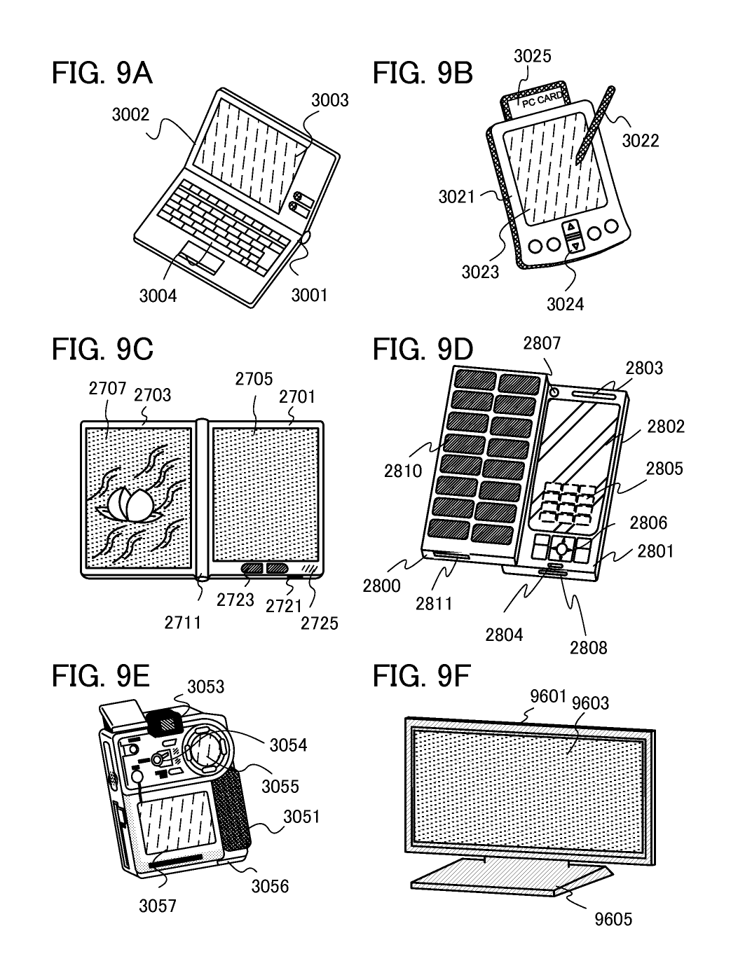

FIG. 9A illustrates a laptop personal computer which includes a main body 3001, a housing 3002, a display portion 3003, a keyboard 3004, and the like. When the liquid crystal display device described in any of Embodiments 1 to 7 is used for the display portion 3003, the laptop personal computer can have high contrast, a high level of visibility, and high reliability.

FIG. 9B is a personal digital assistant (PDA) which includes a main body 3021 provided with a display portion 3023, an external interface 3025, operation buttons 3024, and the like. A stylus 3022 is included as an accessory for operation. When the liquid crystal display device described in any of Embodiments 1 to 7 is used for the display portion 3023, the personal digital assistant (PDA) can have high contrast, a high level of visibility, and high reliability.

FIG. 9C illustrates an example of an electronic book reader which includes two housings, i.e., a housing 2701 and a housing 2703. The housing 2701 and the housing 2703 are combined with a hinge 2711 so that the electronic book reader can be opened and closed with the hinge 2711 as an axis. With such a structure, the electronic book reader can operate like a paper book.

A display portion 2705 and a display portion 2707 are incorporated in the housing 2701 and the housing 2703, respectively. The display portion 2705 and the display portion 2707 may display one image or different images. In the structure where different images are displayed on different display portions, for example, text can be displayed on the right display portion (the display portion 2705 in FIG. 9C) and images can be displayed on the left display portion (the display portion 2707 in FIG. 9C). When the liquid crystal display device described in any of Embodiments 1 to 7 is used for the display portions 2705 and 2707, the electronic book reader can have high contrast, a high level of visibility, and high reliability.

FIG. 9C illustrates an example in which the housing 2701 is provided with an operation portion and the like. For example, the housing 2701 is provided with a power switch 2721, operation keys 2723, a speaker 2725, and the like. With the operation keys 2723, pages can be turned. Note that a keyboard, a pointing device, or the like may also be provided on the surface of the housing, on which the display portion is provided. Furthermore, an external connection terminal (an earphone terminal, a USB terminal, or the like), a recording medium insertion portion, and the like may be provided on the back surface or the side surface of the housing. Moreover, the electronic book reader may have a function of an electronic dictionary.

The electronic book reader may have a structure capable of wirelessly transmitting and receiving data. Through wireless communication, desired book data or the like can be purchased and downloaded from an electronic book server.

FIG. 9D illustrates a mobile phone, which includes two housings, i.e., a housing 2800 and a housing 2801. The housing 2801 includes a display panel 2802, a speaker 2803, a microphone 2804, a pointing device 2806, a camera lens 2807, an external connection terminal 2808, and the like. In addition, the housing 2800 includes a solar cell 2810 having a function of charge of the mobile phone, an external memory slot 2811, and the like. An antenna is incorporated in the housing 2801. When the liquid crystal display device described in any of Embodiments 1 to 7 is used for the display panel 2802, the mobile phone can have high contrast, a high level of visibility, and high reliability.

Further, the display panel 2802 is provided with a touch panel. A plurality of operation keys 2805 which is displayed as images is illustrated by dashed lines in FIG. 9D. Note that a boosting circuit by which a voltage output from the solar cell 2810 is increased to be sufficiently high for each circuit is also provided.

On the display panel 2802, the display direction can be appropriately changed depending on a usage pattern. Further, the mobile phone is provided with the camera lens 2807 on the same surface as the display panel 2802, and thus it can be used as a video phone. The speaker 2803 and the microphone 2804 can be used for videophone calls, recording and playing sound, and the like as well as voice calls. Furthermore, the housings 2800 and 2801 which are developed as illustrated in FIG. 9D can overlap with each other by sliding; thus, the size of the mobile phone can be decreased, which makes the mobile phone suitable for being carried.

The external connection terminal 2808 can be connected to an AC adapter and various types of cables such as a USB cable, and charging and data communication with a personal computer are possible. Moreover, a large amount of data can be stored by inserting a storage medium into the external memory slot 2811 and can be moved.

Further, in addition to the above functions, an infrared communication function, a television reception function, or the like may be provided.

FIG. 9E illustrates a digital video camera which includes a main body 3051, a display portion A 3057, an eyepiece portion 3053, an operation switch 3054, a display portion B 3055, a battery 3056, and the like. When the liquid crystal display device described in any of Embodiments 1 to 7 is used for the display portion A 3057 and the display portion B 3055, the digital video camera can have high contrast, a high level of visibility, and high reliability.

FIG. 9F illustrates a television set. The television set includes a housing 9601, a display portion 9603, and the like. The display portion 9603 can display images. Here, the housing 9601 is supported by a stand 9605. When the liquid crystal display device described in any of Embodiments 1 to 7 is used for the display portion 9603, the television set can have high contrast, a high level of visibility, and high reliability.

The television set can be operated by an operation switch of the housing 9601 or a separate remote controller. Further, the remote controller may be provided with a display portion for displaying data output from the remote controller.

Note that the television set is provided with a receiver, a modem, and the like. With the use of the receiver, general television broadcasting can be received. Moreover, when the television set is connected to a communication network with or without wires via the modem, one-way (from a sender to a receiver) or two-way (between a sender and a receiver or between receivers) data communication can be performed.

This embodiment can be implemented in appropriate combination with any of the structures described in the other embodiments.

### Example 1

In this example, liquid crystal elements (an example sample 1 and an example sample 2) were manufactured using liquid crystal compositions according to any one of embodiments of the present invention, and liquid crystal elements (a comparative example sample 1 and a comparative example sample 2) were manufactured using comparative liquid crystal compositions to which any one of embodiments of the present invention was not applied, as comparative examples. Then, the characteristics thereof were evaluated.

Table 1 shows the structures of the liquid crystal compositions which are contained in the liquid crystal elements (the example sample 1, the example sample 2, the comparative example sample 1, and the comparative example sample 2) manufactured in this example. In Table 1, the mixture ratios are all represented in weight ratios.

TABLE 1

| | | | comparative | comparative | | |
|---|---|---|---|---|---|---|
| | example | example | example | example | ratio | |
| Sample | sample 1 | sample 2 | sample 1 | sample 2 | (wt %) | |
| Liquid | CPP- | CPP- | CPP- | CPP- | 50 | 92.5 |
| crystal | 3FCNF | 3FFF | 3CN | 3FF | | |

| | | | |
|---|---|---|---|
| | E-8 | 50 | |
| Chiral | ISO-(6OBA)₂ | | 7.5 |
| agent | | | |

As a chiral agent, 1,4:3,6-dianhydro-2,5-bis[4-(n-hexyl-1-oxy)benzoic acid]sorbitol (abbreviation: ISO-(6OBA)₂) (manufactured by Midori Kagaku Co., Ltd.) was used. For liquid crystal, liquid crystal mixture E-8 (manufactured by LCC Corporation) was used for all the samples, and CPP-3FCNF (abbreviation) was also used for the example sample 1; CPP-3FFF (abbreviation) was also used for the example sample 2; 4-[4-(trans-4-n-propylcyclohexyl)phenyl]benzonitrile (abbreviation: CPP-3CN) expressed by a structural formula (111) was also used for the comparative example sample 1; and 4-(trans-4-n-propylcyclohexyl)-3′,4′-difluoro-1,1′-biphenyl (abbreviation: CPP-3FF) expressed by a structural formula (112) (manufactured by Daily Polymer Corporation) was also used for the comparative example sample 2.

Note that the structural formulas of CPP-3FCNF (abbreviation), CPP-3FFF (abbreviation), CPP-3CN (abbreviation), CPP-3FF (abbreviation), and ISO-(6OBA)₂ (abbreviation) are shown below.

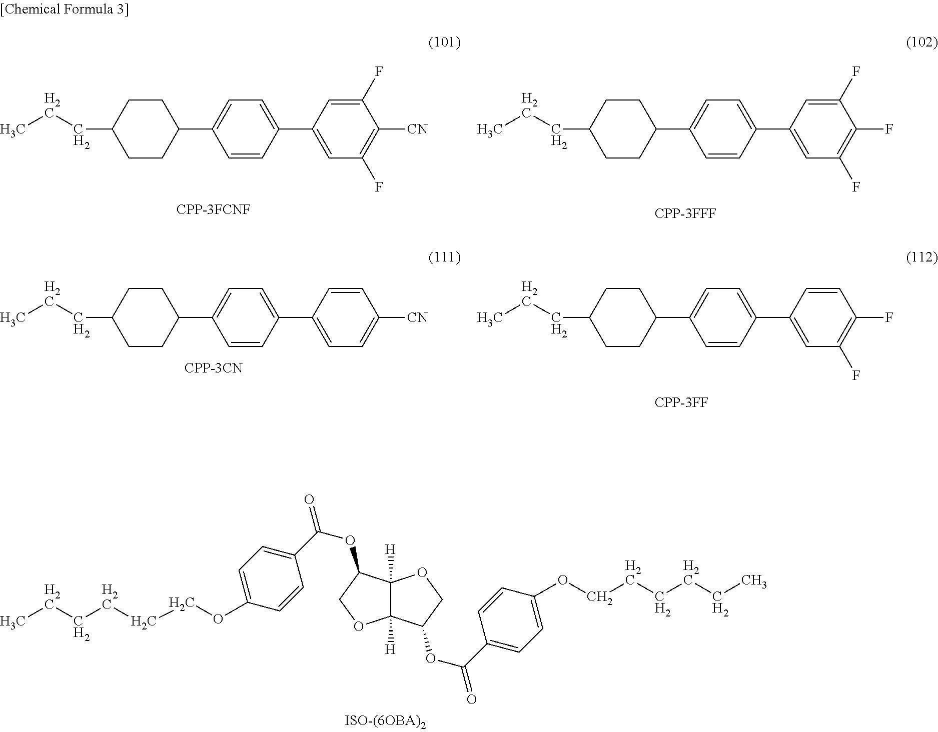

The liquid crystal elements of the example sample 1, the example sample 2, the comparative example sample 1, and the comparative example sample 2 were each manufactured in such a manner that a glass substrate over which a pixel electrode layer and a common electrode layer were formed in comb-like shapes as in FIG. 3D and a glass substrate serving as a counter substrate were bonded to each other using sealant with a space (4 μm) provided therebetween and then a liquid crystal composition obtained by mixing materials in Table 1 stirred in an isotropic phase at a ratio shown in Table 1 was injected between the substrates by an injection method.

The pixel electrode layer and the common electrode layer were formed using indium tin oxide containing silicon oxide (ITSO) by a sputtering method. The thickness of each of the pixel electrode layer and the common electrode layer was 110 nm, the width thereof was 2 μm, and the distance between the pixel electrode layer and the common electrode layer was 2 μm. Further, an ultraviolet light and heat curable sealant was used as the sealant. As curing treatment, ultraviolet (irradiance of 100 mW/cm²) irradiation was performed for 90 seconds, and then, heat treatment was performed at 120° C. for 1 hour.

The reflectance spectra of the liquid crystal compositions in the liquid crystal elements of the example sample 1, the example sample 2, the comparative example sample 1, and the comparative example sample 2, were evaluated. The evaluation was performed using a polarizing microscope (MX-61L manufactured by Olympus Corporation), a temperature controller (HCS302-MK1000 manufactured by Instec, Inc.), and a microspectroscope (LVmicroUV/VIS manufactured by Lambda Vision Inc.).

First, the liquid crystal compositions in the liquid crystal elements of the example sample 1, the example sample 2, the comparative example sample 1, and the comparative example sample 2 were made to exhibit an isotropic phase. Then, the liquid crystal compositions were observed with the polarizing microscope while the temperature was decreased by 1.0° C. per minute with the temperature controller. In this manner, the temperature range where the liquid crystal compositions exhibit a blue phase was measured.

The measurement conditions of the observation were as follows. In the polarizing microscope, a measurement mode was a reflective mode; polarizers were in crossed nicols; and the magnification was 50 times to 200 times.

Next, each of the liquid crystal elements of the example sample 1, the example sample 2, the comparative example sample 1, and the comparative example sample 2 was set at a given constant temperature within the temperature range where a blue phase was exhibited, and the spectra of the intensity of reflected light from the liquid crystal compositions were measured with the microspectroscope.

The measurement conditions of the microspectroscope were as follows. A measurement mode was a reflective mode; polarizers were in crossed nicols; the measurement area was 12 μmφ; and the measurement wavelength was 250 nm to 800 nm. Since the measurement area is small, for the measurement, an area where the color of a blue phase had a long wavelength was determined with a monitor of the microspectroscope. Note that the measurement was performed from the side of the glass substrate serving as the counter substrate, over which the pixel electrode layer and the common electrode layer were not formed, in order to avoid an influence of the electrode layers in measurement.

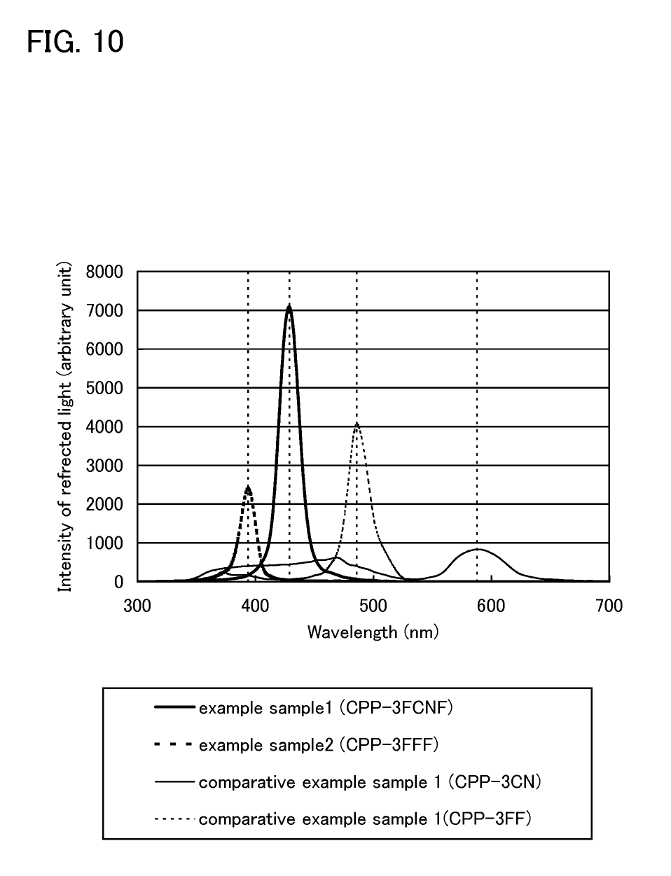

FIG. 10 shows the spectra of the intensity of reflected light from the liquid crystal compositions in the liquid crystal elements of the example sample 1, the example sample 2, the comparative example sample 1, and the comparative example sample 2 (the spectrum of the liquid crystal composition in the example sample 1 is represented by a thick solid line, the spectrum of the liquid crystal composition in the example sample 2 is represented by a thick dotted line, the spectrum of the liquid crystal composition in the comparative example sample 1 is represented by a thin solid line, and the spectrum of the liquid crystal composition in the comparative example sample 2 is represented by a thin dotted line). The peaks of the diffracted wavelengths on the longest wavelength side in the reflectance spectra of the liquid crystal compositions in the liquid crystal elements of the example sample 1, the example sample 2, the comparative example sample 1, and the comparative example sample 2 were detected.

The detected peak of the diffracted wavelength in the reflectance spectrum has the maximum value and is on the longest wavelength side among peaks. For example, although the comparative example sample 1 has two peaks at around 480 nm and around 580 nm, the peak with the maximum value at around 580 nm on the long wavelength side was detected. Further, a peak with the maximum value is the peak of the diffracted wavelength even when the peak has a shoulder (a level difference or a low peak).

The peaks of the diffracted wavelengths on the longest wavelength side in the reflectance spectra of the liquid crystal compositions were 429 nm in the example sample 1 which is one embodiment of the present invention, and 394 nm in the example sample 2 which is one embodiment of the present invention. That is, the peaks of the diffracted wavelengths in the reflectance spectra of the liquid crystal composition in the example sample 1 and the example sample 2 were less than 450 nm. Thus, the peaks of the diffracted wavelengths in the reflectance spectra of the liquid crystal compositions in the liquid crystal elements of the example sample 1 and the example sample 2, which contained CPP-3FCNF (abbreviation) and CPP-3FFF (abbreviation), respectively, were less than 450 nm. Note that CPP-3FCNF and CPP-3FFF are compounds each having three electron-withdrawing groups as end groups of a structure where a plurality of rings including at least one aromatic ring are linked to each other directly or with a linking group laid therebetween. This result reveals that the twisting power of the liquid crystal compositions is strong.

On the other hand, the peaks of the diffracted wavelengths of the liquid crystal compositions of the comparative example sample 1 and the comparative example sample 2, which were compounds each not having three electron-withdrawing groups as end groups of a structure where a plurality of rings including at least one aromatic ring are linked to each other directly or with a linking group laid therebetween, were 486 nm and 588 nm, respectively, which were longer wavelengths than 450 nm. This result reveals that the twisting power of the liquid crystal compositions is weaker than those of the present invention.

When the twisting power of the liquid crystal composition is strong, the transmittance of the liquid crystal composition in application of no voltage (at an applied voltage of 0 V) can be low, leading to a higher contrast of a liquid crystal display device including the liquid crystal composition.

Thus, in this example, with the use of the liquid crystal composition exhibiting a blue phase, according to one embodiment of the present invention, a liquid crystal display device with higher contrast can be provided.

### Example 2

In this example, liquid crystal elements (example samples 3A to 6A and 3B to 6B) were manufactured using liquid crystal compositions according to embodiments of the present invention, and liquid crystal compositions (comparative example samples 3A and 3B) were manufactured using liquid crystal compositions to which one embodiment of the present invention was not applied, as comparative examples. Then, the characteristics thereof were evaluated.

Table 2 shows the structures of the liquid crystal compositions which are contained in the liquid crystal elements (the example samples 3A to 6A and 3B to 6B, and the comparative example samples 3A and 3B) manufactured in this example. In Table 2, the ratios (the mixture ratios) are all represented in weight ratios. The example samples 3A to 6A and the comparative example sample 3A are liquid crystal elements containing liquid crystal compositions each containing liquid crystal and a chiral agent, and the example samples 3B to 6B and the comparative example sample 3B are liquid crystal elements containing liquid crystal compositions obtained by adding polymerizable monomers and polymerization initiators to the example samples 3A to 6A and the comparative example sample 3A.

TABLE 2

| | | example | example | example | example | comparative | | | |
|---|---|---|---|---|---|---|---|---|---|
| | | sample | sample | sample | sample | example | ratio | | |
| Sample | | 3B | 4B | 5B | 6B | sample 3B | (wt %) | | |
| polymerization | | DMPAP | | | | | | | 0.3 |
| initiator | | | | | | | | | |
| Polymerizable | | DMeAc | | | | | | 4 | |
| monomer | | RM257 | | | | | | 4 | |
| | | example | example | example | example | comparative | | | |
| | | sample | sample | sample | sample | example | | | |
| Sample | | 3A | 4A | 5A | 6A | sample 3A | | | |
| Liquid | CPEP- | 40 | 50 | 45 | 40 | 30 | 90.5 | 92 | 99.7 |
| crystal | 5FCNF | | | | | | | | |
| | PEP- | 0 | 0 | 10 | 20 | 0 | | | |
| | 3FCNF | | | | | | | | |
| | CPEP- | 0 | 0 | 0 | 0 | 20 | | | |
| | 5CNF | | | | | | | | |
| | PEP- | 20 | 0 | 0 | 0 | 10 | | | |
| | 3CNF | | | | | | | | |
| | E-8 | 40 | 50 | 45 | 40 | 40 | | | |

| | | |
|---|---|---|
| Chiral agent | ISO(6OBA)₂ | 9.5 |

In the example samples 3A to 6A and 3B to 6B, and the comparative example samples 3A and 3B, ISO-(6OBA)₂ (abbreviation) (manufactured by Midori Kagaku Co., Ltd.) was used as a chiral agent. For liquid crystal, liquid crystal mixture E-8 (manufactured by LCC Corporation) was used for all the samples, and CPEP-5FCNF (abbreviation) and 4-n-propyl benzoic acid 3-fluoro-4-cyanophenyl (abbreviation: PEP-3CNF) expressed by a structural formula (114) were also used for the example samples 3A and 3B; CPEP-5FCNF (abbreviation) was also used for the example samples 4A and 4B; CPEP-5FCNF (abbreviation) and PEP-3FCNF (abbreviation) were also used for the example samples 5A, 5B, 6A, and 6B; and CPEP-5FCNF (abbreviation), 4-(trans-4-n-pentylcyclohexyl)benzoic acid 4-cyano-3-fluorophenyl (abbreviation: CPEP-5CNF) expressed by a structural formula (113), and PEP-3CNF (abbreviation) were also used for the comparative example samples 3A and 3B.

In the example samples 3B to 6B and the comparative example sample 3B, dodecyl methacrylate (abbreviation: DMeAc) (manufactured by Tokyo Chemical Industry Co., Ltd.) which is a polymerizable monomer which is non-liquid crystalline and UV-polymerizable and RM257 (manufactured by Merck Ltd.) which is a polymerizable monomer which is liquid crystalline and UV-polymerizable were used as polymerizable monomers. As a polymerization initiator, DMPAP (abbreviation) (manufactured by Tokyo Chemical Industry Co., Ltd.) was used.

In the liquid crystal compositions of the example samples 3A to 6A and the comparative example sample 3A, the proportions of the liquid crystal and the chiral agent were 90.5 wt % and 9.5 wt %, respectively. In the liquid crystal compositions of the example samples 3B to 6B and the comparative example sample 3B, the proportion of the liquid crystal and the chiral agent and the proportion of the polymerizable monomer were 92 wt % and 8 wt % (the proportion of DMeAc was 4 wt % and the proportion of RM257 was 4 wt %), respectively. Further, in the liquid crystal compositions of the example samples 3B to 6B and the comparative example sample 3B, the proportion of the liquid crystal, the chiral agent, and the polymerizable monomer and the proportion of the polymerization initiator were 99.7 wt % and 0.3 wt %, respectively.

The proportions of the compound/compounds having three electron-withdrawing groups as end groups of a structure where a plurality of rings including at least one aromatic ring are linked to each other directly or with a linking group laid therebetween (CPEP-5FCNF (abbreviation) or/and PEP-3FCNF (abbreviation)) in the liquid crystal were 40 wt % in the example samples 3A and 3B, 50 wt % in the example samples 4A and 4B, 55 wt % in the example samples 5A and 5B, 60 wt % in the example samples 6A and 6B, and 30 wt % in the comparative example samples 3A and 3B.

Note that the structural formulas of CPEP-5FCNF (abbreviation), PEP-3FCNF (abbreviation), CPEP-5CNF (abbreviation), PEP-3CNF (abbreviation), RM257 (manufactured by Merck Ltd.), dodecyl methacrylate (abbreviation: DMeAc) (manufactured by Tokyo Chemical Industry Co., Ltd.), and DMPAP (abbreviation) (manufactured by Tokyo Chemical Industry Co., Ltd.) as the polymerization initiator are shown below.

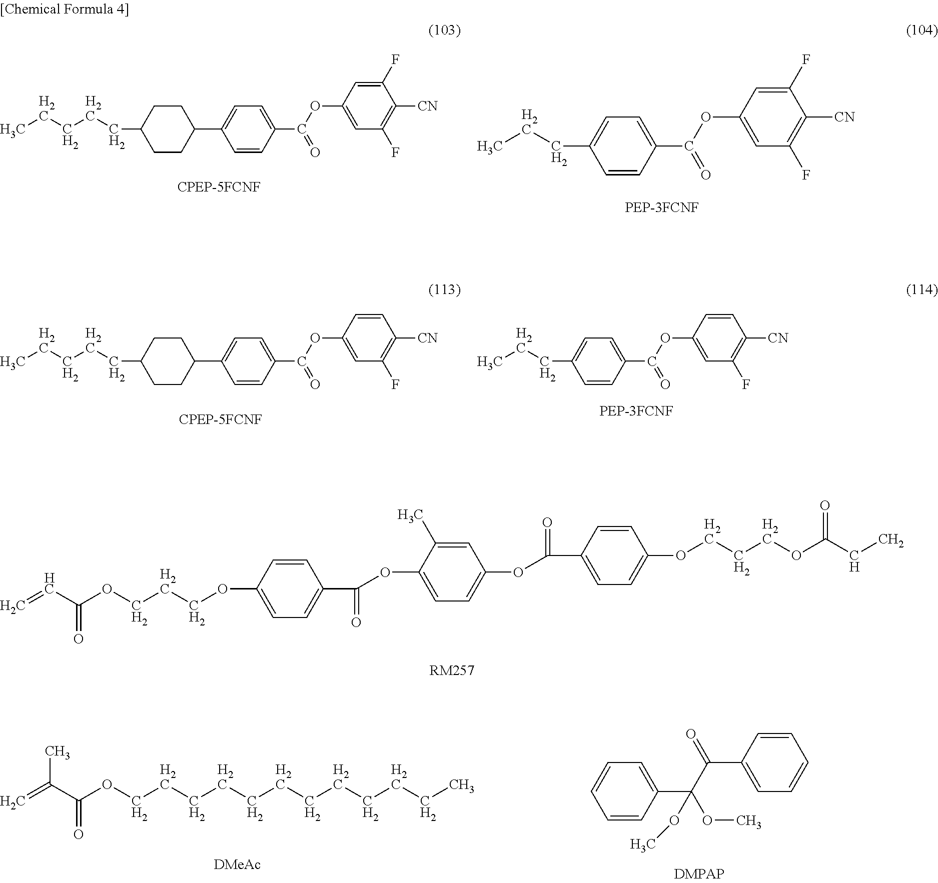

The liquid crystal elements of the example samples 3A to 6A and 3B to 6B and the comparative example samples 3A and 3B were each manufactured in such a manner that a glass substrate over which a pixel electrode layer and a common electrode layer were formed in comb-like shapes as in FIG. 3D and a glass substrate serving as a counter substrate were bonded to each other using sealant with a space (4 μm) provided therebetween and then a liquid crystal composition obtained by mixing materials in Table 2 stirred in an isotropic phase at a ratio shown in Table 2 was injected between the substrates by an injection method.

The pixel electrode layer and the common electrode layer were formed using indium tin oxide containing silicon oxide (ITSO) by a sputtering method. The thickness of each of the pixel electrode layer and the common electrode layer was 110 nm, the width thereof was 2 μm, and the distance between the pixel electrode layer and the common electrode layer was 2 μm. Further, an ultraviolet light and heat curable sealant was used as the sealant. As curing treatment, ultraviolet (irradiance of 100 mW/cm²) irradiation was performed for 90 seconds, and then, heat treatment was performed at 120° C. for 1 hour.

The reflectance spectra of the liquid crystal compositions in the liquid crystal elements of the example samples 3A to 6A and the comparative example sample 3A were evaluated. The evaluation was performed using the polarizing microscope (MX-61L manufactured by Olympus Corporation), the temperature controller (HCS302-MK1000 manufactured by Instec, Inc.), and the microspectroscope (LVmicroUV/VIS manufactured by Lambda Vision Inc.).

First, the liquid crystal compositions in the liquid crystal elements of the example samples 3A to 6A and the comparative example sample 3A were made to exhibit an isotropic phase. Then, the liquid crystal elements were observed with the polarizing microscope while the temperature was decreased by 1.0° C. per minute with the temperature controller. In this manner, the temperature range where the liquid crystal compositions exhibit a blue phase was measured.

The measurement conditions of the observation were as follows. In the polarizing microscope, a measurement mode was a reflective mode; polarizers were in crossed nicols; and the magnification was 50 times to 200 times.

Next, each of the liquid crystal elements of the example samples 3A to 6A and the comparative example sample 3A was set at a given constant temperature within the temperature range where a blue phase was exhibited, and the spectra of the intensity of reflected light from the liquid crystal compositions were measured with the microspectroscope.

The measurement conditions of the microspectroscope were as follows. A measurement mode was a reflective mode; polarizers were in crossed nicols; the measurement area was 12 μmφ; and the measurement wavelength was 250 nm to 800 nm. Since the measurement area is small, for the measurement, an area where the color of a blue phase had a long wavelength was determined with a monitor of the microspectroscope. Note that the measurement was performed from the side of the glass substrate serving as the counter substrate, over which the pixel electrode layer and the common electrode layer are not formed, in order to avoid an influence of the electrode layers in measurement.

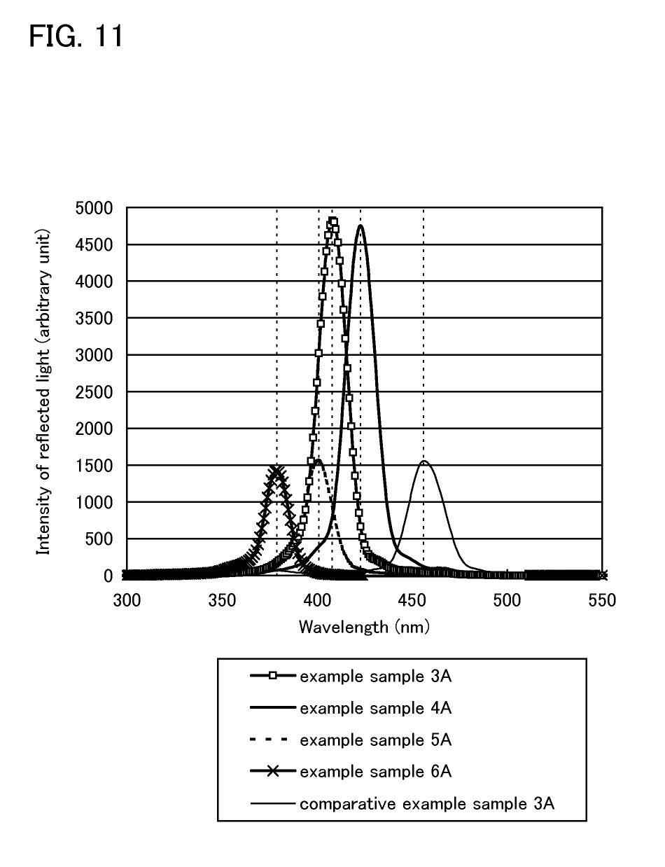

FIG. 11 shows the spectra of the intensity of reflected light from the liquid crystal compositions in the liquid crystal elements of the example samples 3A to 6A and the comparative example sample 3A (the spectrum of the liquid crystal composition in the example sample 3A is represented by a thick solid line with square dots, the spectrum of the liquid crystal composition in the example sample 4A is represented by a thick solid line, the spectrum of the liquid crystal composition in the example sample 5A is represented by a thick dotted line, the spectrum of the liquid crystal composition in the example sample 6A is represented by a thick solid line with x-marks, and the spectrum of the liquid crystal composition in the comparative example sample 3A is represented by a thin solid line). The peaks of the diffracted wavelengths on the longest wavelength side in the reflectance spectra of the liquid crystal compositions of the liquid crystal elements of the example samples 3A to 6A and the comparative example sample 3A were detected.

Also in this example, the detected peak of the diffracted wavelength in the reflectance spectrum has the maximum value and is on the longest wavelength side among peaks.

The peaks of the diffracted wavelengths on the longest wavelength side in the reflectance spectra of the liquid crystal compositions were 408 nm in the example sample 3A which is one embodiment of the present invention, 423 nm in the example sample 4A which is one embodiment of the present invention, 401 nm in the example sample 5A which is one embodiment of the present invention, and 379 nm in the example sample 6A which is one embodiment of the present invention. That is, the peaks of the diffracted wavelengths in the reflectance spectra of the liquid crystal compositions in the example samples 3A to 6A were less than 450 nm. Thus, the peaks of the diffracted wavelengths in the reflectance spectra of the liquid crystal compositions of the liquid crystal elements of the example samples 3A to 6A which contained CPEP-5FCNF (abbreviation) and/or PEP-3FCNF (abbreviation) were less than 450 nm. Note that CPEP-5FCNF and PEP-3FCNF are compounds each having three electron-withdrawing groups as end groups of a structure where a plurality of rings including at least one aromatic ring is linked to each other directly or with a linking group laid therebetween. This result reveals that the twisting power of the liquid crystal compositions is strong.

On the other hand, the peak of the diffracted wavelength on the longest wavelength side in the reflectance spectrum of the comparative example sample 3A was 456 nm which is a longer wavelength than 450 nm. This result reveals that the twisting power of the liquid crystal composition is weaker than those of the present invention.

The liquid crystal elements of the example samples 3B to 6B and the comparative example sample 3B were subjected to polymer stabilization treatment. The polymer stabilization treatment was performed in such a manner that the liquid crystal compositions of the liquid crystal elements, the example samples 3B to 6B and the comparative example sample 3B, were set at a given constant temperature within the temperature range where a blue phase was exhibited, and ultraviolet light (peak wavelength of 365 nm, irradiance of 1.5 mW/cm²) irradiation was performed for 30 minutes. Through the polymer stabilization treatment, the polymerizable monomers in the liquid crystal compositions in the example samples 3B to 6B and the comparative example sample 3B polymerized, so that the liquid crystal elements containing the liquid crystal compositions containing an organic resin were formed as the example samples 3B to 6B and the comparative example sample 3B.

Next, in the liquid crystal elements of the example samples 3B to 6B and the comparative example sample 3B containing the liquid crystal compositions, which were subjected to the polymer stabilization treatment, the spectra of the intensity of reflected light from the liquid crystal compositions were measured at room temperature with the microspectroscope.

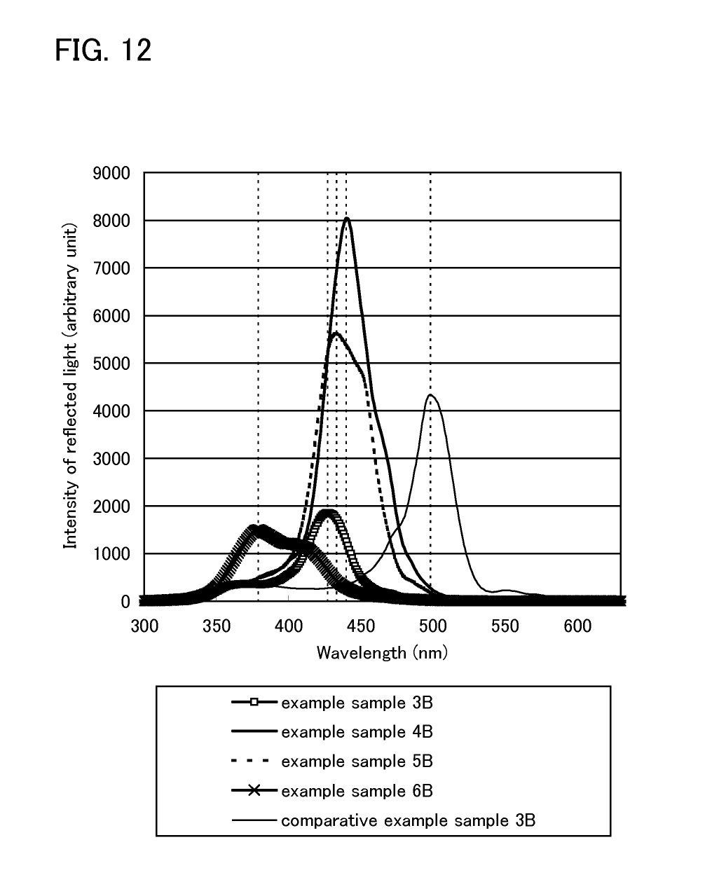

FIG. 12 shows the spectra of the intensity of reflected light from the liquid crystal compositions of the liquid crystal elements of the example samples 3B to 6B and the comparative example sample 3B (the spectrum of the liquid crystal composition in the example sample 3B is represented by a thick solid line with square dots, the spectrum of the liquid crystal composition in the example sample 4B is represented by a thick solid line, the spectrum of the liquid crystal composition in the example sample 5B is represented by a thick dotted line, the spectrum of the liquid crystal composition in the example sample 6B is represented by a thick solid line with x-marks, and the spectrum of the liquid crystal composition in the comparative example sample 3B is represented by a thin solid line). The peaks of the diffracted wavelengths on the longest wavelength side in the reflectance spectra of the liquid crystal compositions in the liquid crystal elements of the example samples 3B to 6B and the comparative example sample 3B were detected.

The peaks of the diffracted wavelengths on the longest wavelength side in the reflectance spectra were 427 nm in the example sample 3B which is one embodiment of the present invention, 440 nm in the example sample 4B which is one embodiment of the present invention, 433 nm in the example sample 5B which is one embodiment of the present invention, and 379 nm in the example sample 6B which is one embodiment of the present invention. That is, the peaks of the diffracted wavelengths in the reflectance spectra of the liquid crystal composition in the example samples 3B to 6B were less than 450 nm. Thus, the peaks of the diffracted wavelengths in the reflectance spectra of the liquid crystal compositions of the liquid crystal elements which were subjected to the polymer stabilization treatment were also less than 450 nm. This result reveals that the twisting power of the liquid crystal compositions of the example samples 3B to 6B containing CPEP-5FCNF (abbreviation) and/or PEP-3FCNF (abbreviation) which are compounds each having three electron-withdrawing groups as end groups of a structure where a plurality of rings including at least one aromatic ring are linked to each other directly or with a linking group laid therebetween is strong.

On the other hand, the peak of the diffracted wavelength on the longest wavelength side in the reflectance spectrum of the liquid crystal composition in the comparative example sample 3B was 498 nm which is a longer wavelength than 450 nm. This result reveals that the twisting power of the liquid crystal composition in the liquid crystal element which was subjected to the polymer stabilization treatment is also weak.

Since the twisting power of the liquid crystal compositions in the example samples 3A to 6A and 3B to 6B in which the proportion of the compounds each having three electron-withdrawing groups as end groups of a structure where a plurality of rings including at least one aromatic ring are linked to each other directly or with a linking group laid therebetween (CPEP-5FCNF (abbreviation) and/or PEP-3FCNF (abbreviation)) in the liquid crystal is 40 wt % or more is strong, it can be confirmed that the proportion of a compound in liquid crystal, which has three electron-withdrawing groups as end groups of a structure where a plurality of rings including at least one aromatic ring are linked to each other directly or with a linking group laid therebetween, is preferably 40 wt % or more.

Further, voltage was applied to the liquid crystal elements of the example samples 3B to 6B and the comparative example sample 3B, and the properties of the transmittance and the contrast with respect to the applied voltage were evaluated. The properties were evaluated using liquid crystal evaluation equipment (an RETS-100+VT measurement system manufactured by Otsuka Electronics Co., Ltd.) with the liquid crystal elements of the example samples 3B to 6B and the comparative example sample 3B sandwiched between polarizers in crossed nicols under the following conditions: a light source was a halogen lamp; and the temperature was room temperature.

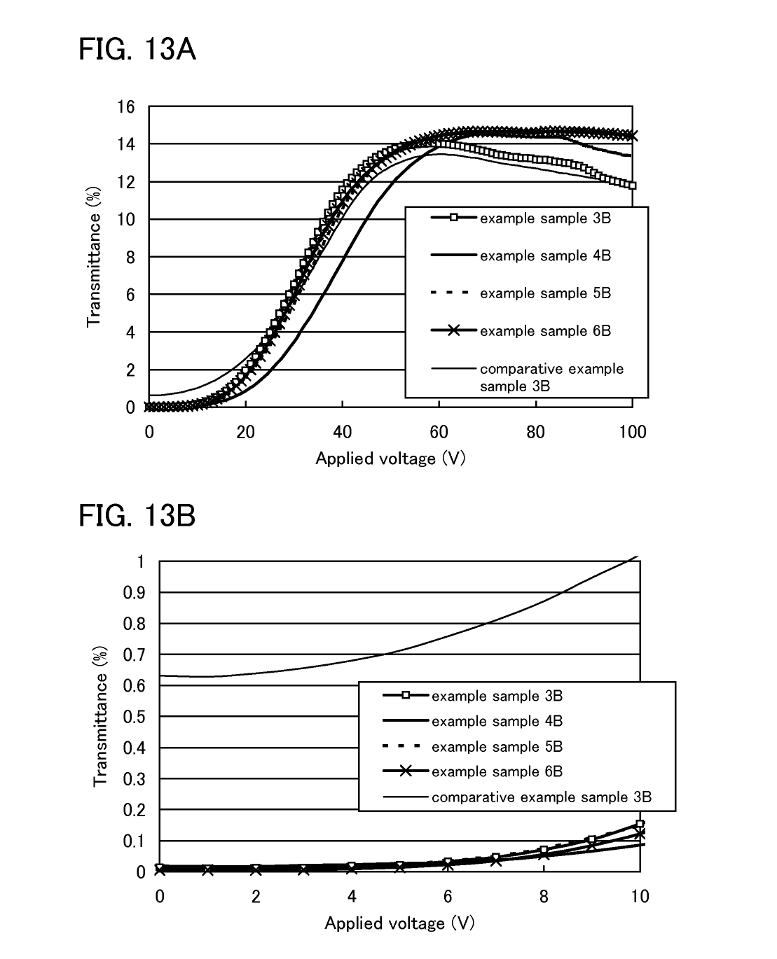

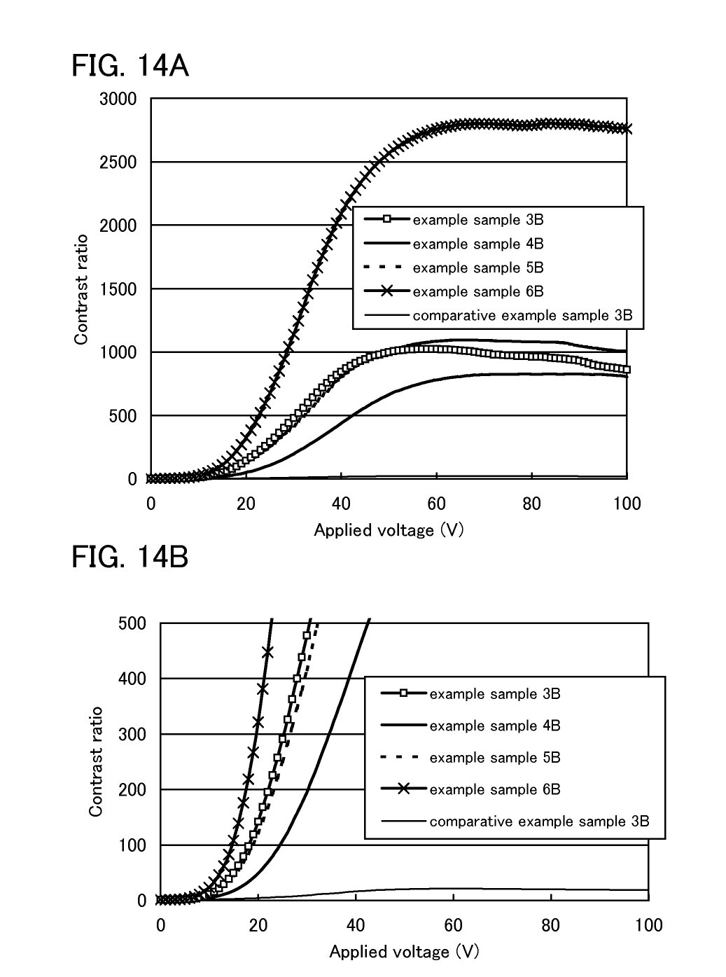

FIGS. 13A and 13B show the relation between applied voltage and transmittance of the liquid crystal elements of the example samples 3B to 6B and the comparative example sample 3B. FIGS. 14A and 14B show the relation between applied voltage and contrast ratio of the liquid crystal elements of the example samples 3B to 6B and the comparative example sample 3B. The transmittance in FIGS. 13A and 13B is the ratio of the intensity of light through the liquid crystal element to the intensity of light from the light source. The contrast ratios with respect to the applied voltage in FIGS. 14A and 14B were calculated from the transmittance in FIGS. 13A and 13B. Specifically, the contrast ratio in application of no voltage (at an applied voltage of 0 V) was assumed to be 1, and the transmittance at each applied voltage was divided by the transmittance at an applied voltage of 0 V. In this manner, the contrast ratio was calculated. Note that in FIGS. 13A and 13B and FIGS. 14A and 14B, the properties of the liquid crystal element of the example sample 3B are represented by a thick solid line with square dots; the properties of the liquid crystal element of the example sample 4B are represented by a thick solid line; the properties of the liquid crystal element of the example sample 5B are represented by a thick dotted line; the properties of the liquid crystal element of the example sample 6B are represented by a thick solid line with x-marks; and the properties of the liquid crystal element of the comparative example sample 3B are represented by a thin solid line. FIG. 13B is an enlarged graph showing the range of the applied voltage of 0 V to 10 V in FIG. 13A. FIG. 14B is an enlarged graph showing the range of the contrast ratio of 0 to 500 in FIG. 14A.

As shown in FIGS. 13A and 13B, the transmittance of the liquid crystal elements of the example samples 3B to 6B at an applied voltage of 0 V is lower than that of the liquid crystal element of the comparative example sample 3B at an applied voltage of 0 V. When voltage is applied, the transmittance of the liquid crystal elements of the example samples 3B to 6B is higher than that of the liquid crystal element of the comparative example sample 3B. The liquid crystal elements of the example samples 3B to 6B are remarkable different from the liquid crystal element of the comparative example sample 3B in the contrast ratio as shown in FIGS. 14A and 14B. At the same applied voltage, the contrast ratio of the liquid crystal elements of the example samples 3B to 6B is higher than that of the liquid crystal element of the comparative example sample 3B.

As described above, when the twisting power of the liquid crystal composition is strong, the transmittance of the liquid crystal composition in application of no voltage (at an applied voltage of 0 V) can be low, leading to a higher contrast of a liquid crystal display device including the liquid crystal composition.

Thus, with the use of the liquid crystal composition exhibiting a blue phase in this example, which is one embodiment of the present invention, a liquid crystal display device with higher contrast can be provided.

### Example 3

Synthetic methods of CPP-3FCNF (abbreviation), CPP-3FFF (abbreviation), CPP-3CN (abbreviation), CPEP-5FCNF (abbreviation), PEP-3FCNF (abbreviation), CPEP-5CNF (abbreviation), and PEP-3CNF (abbreviation), which were used for Examples 1 and 2 are described below.

### Synthetic Method of 4-[4-(trans-4-n-propylcyclohexyl)phenyl]-2,6-difluorobenzonitrile (Abbreviation: CPP-3FCNF)

A synthetic scheme of CPP-3FCNF (abbreviation) represented by the structural formula (101) is shown in (D-2) below.

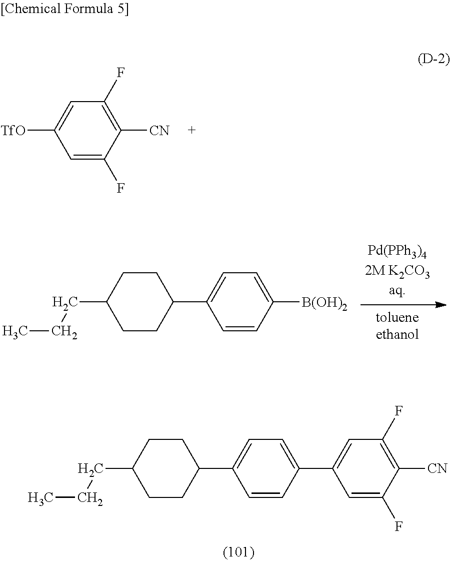

Into a 100-mL three-neck flask were put 2.5 g (8.7 mmol) of trifluoromethanesulfonic acid 4-cyano-3,5-difluorophenyl and 2.4 g (9.8 mmol) of 4-(trans-4-n-propylcyclohexyl)phenylboronic acid, and the atmosphere in the flask was replaced with nitrogen. To the mixture, 9.6 mL of 2.0M potassium carbonate solution, 33 mL of toluene, and 11 mL of ethanol were added and this mixture was degassed by being stirred under reduced pressure. To the mixture, 0.30 g (0.26 mmol) of tetrakis(triphenylphosphine)palladium(0) was added and this mixture was stirred at 90° C. for 3 hours under a nitrogen stream. After predetermined time passed, an aqueous layer of the obtained mixture was extracted with ethyl acetate. The obtained extract and an organic layer were combined, and the mixture was washed with saturated saline and then dried with magnesium sulfate. This mixture was separated by gravity filtration, and the filtrate was concentrated to give a white solid. This solid was purified by silica gel column chromatography (developing solvent: hexane). The obtained fraction was condensed to give a solid. This solid was purified by high performance liquid chromatography (HPLC) (developing solvent: chloroform). The obtained fraction was concentrated to give 2.1 g of a white solid, which was a substance to be produced, in a yield of 70%.

Then, 2.1 g of the obtained white solid was purified by sublimation using a train sublimation method. In the purification by sublimation, the white solid was heated at 140° C. under a pressure of 2.5 Pa with a flow rate of argon gas of 5 mL/min. After the purification by sublimation, 1.8 g of a white solid was obtained in a yield of 86%.

This compound was identified as 4-[4-(trans-4-n-propylcyclohexyl)phenyl]-2,6-difluorobenzonitrile (abbreviation: CPP-3FCNF), which was the substance to be produced, by nuclear magnetic resonance (NMR) spectroscopy.

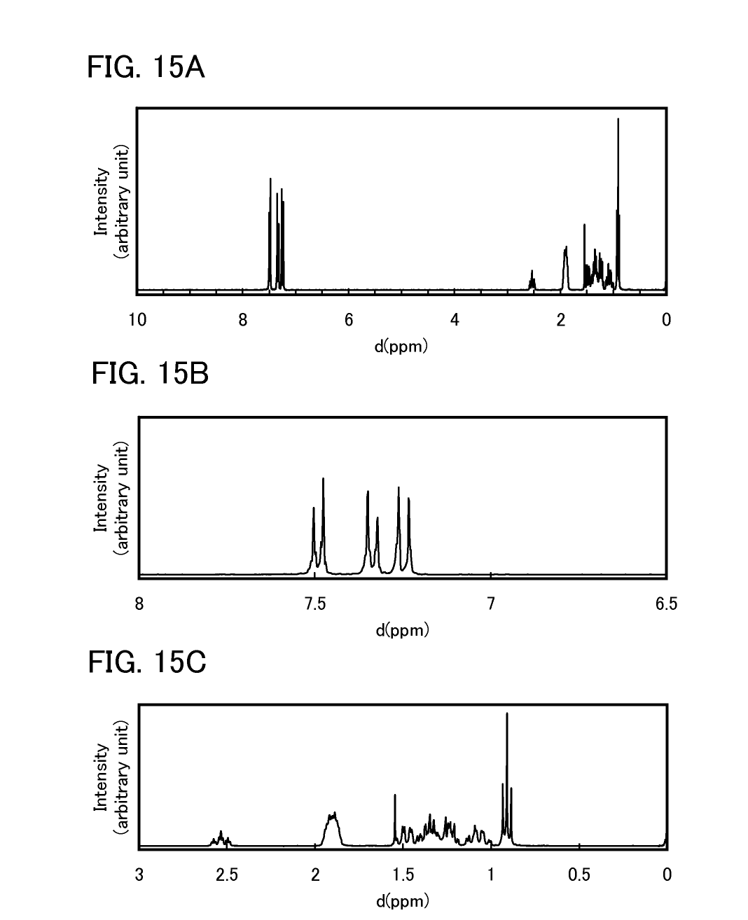

The ¹H NMR data of the obtained substance (CPP-3FCNF) is shown below. ¹H NMR (CDCl₃, 300 MHz): δ (ppm)=0.91 (t, 3H), 1.00-1.14 (m, 2H), 1.18-1.53 (m, 7H), 1.88-1.93 (m, 4H), 2.48-2.59 (m, 1H), 7.25 (d, 2H), 7.34 (d, 2H), 7.49 (d, 2H). In addition, FIGS. 15A to 15C are ¹H NMR charts. Note that FIG. 15B is an enlarged chart showing the range of 6.5 ppm to 8.0 ppm in FIG. 15A. Note also that FIG. 15C is an enlarged chart showing the range of 0.0 ppm to 3.0 ppm in FIG. 15A.

### Synthetic Method of 4-(trans-4-n-propylcyclohexyl)-3′,4′,5′-trifluoro-1,1′-biphenyl (Abbreviation: CPP-3FFF)

### Step 1: Synthesis of Trifluoromethanesulfonic acid 4-(trans-4-n-propylcyclohexyl)phenyl

A synthetic scheme of trifluoromethanesulfonic acid 4-(trans-4-n-propylcyclohexyl)phenyl is shown in (E-1) below.

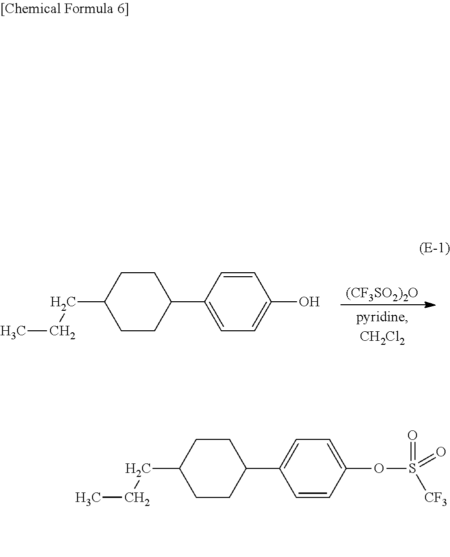

Into a 300-mL recovery flask were put 10 g (46 mmol) of 4-(trans-n-propylhexyl)phenol, 100 mL of dichloromethane, and 7.3 g (92 mmol) of pyridine, stirring was performed, and this solution was cooled to 0° C. After the cooling, a solution in which 25 g (92 mmol) of trifluoromethanesulfonic acid anhydride was dissolved in 50 mL of dichloromethane was dropped from a dropping funnel at the same temperature. After the dropping, the temperature of this solution was raised to room temperature, the solution was stirred for 15 hours at the same temperature and cooled to 0° C., and water was added to the solution slowly to inactivate part of the trifluoromethanesulfonic acid anhydride, which did not react. An aqueous layer of the obtained mixture was extracted with dichloromethane. The obtained extract and an organic layer were combined, and the mixture was washed with a dilute hydrochloric acid, water, and saturated saline and then dried with magnesium sulfate. This mixture was separated by gravity filtration, and the filtrate was concentrated to give an oily substance. This oily substance was purified by silica gel column chromatography. The silica gel column chromatography was conducted using a developing solvent of toluene and hexane (toluene:hexane=1:1). The obtained fraction was concentrated to give 2.1 g of a white solid, which was a substance to be produced, in a yield of 70%.

### Step 2: Synthesis of 4-(trans-4-n-propylcyclohexyl)-3′,4′,5′-trifluoro-1,1′-biphenyl (Abbreviation: CPP-3FFF)

A synthetic scheme of CPP-3FFF represented by the structural formula (102) is shown in (E-2) below.

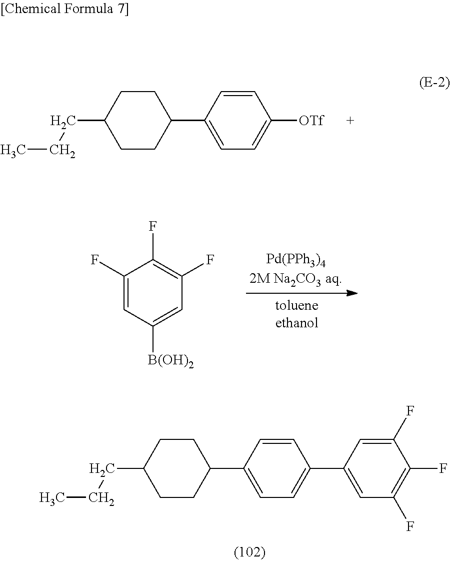

Into a 100-mL three-neck flask was put 1.7 g (9.7 mmol) of 3,4,5-trifluorophenylboronic acid, and the atmosphere in the flask was replaced with nitrogen. To the mixture, 3.1 g (8.8 mmol) of trifluoromethanesulfonic acid 4-(trans-4-n-propylcyclohexyl)phenyl, 10 mL of 2.0M potassium carbonate solution, 34 mL of toluene, and 11 mL of ethanol were added and this mixture was degassed by being stirred under reduced pressure. To the mixture, 0.31 g (0.27 mmol) of tetrakis(triphenylphosphine)palladium(0) was added and this mixture was stirred at 90° C. for 3.5 hours under a nitrogen stream. After predetermined time passed, water was added to the obtained mixture to extract an aqueous layer with toluene. The obtained extract and an organic layer were combined, and the mixture was washed with saturated saline and then dried with magnesium sulfate. This mixture was separated by gravity filtration, and the filtrate was concentrated to give an oily substance. This oily substance was purified by silica gel column chromatography (developing solvent: hexane). The obtained fraction was condensed to give a solid. This solid was purified by high performance liquid chromatography (HPLC) (developing solvent: chloroform). The obtained fraction was concentrated to give 2.1 g of a white solid, which was a substance to be produced, in a yield of 70%.

Then, 1.4 g of the obtained white solid was purified by sublimation using a train sublimation method. In the purification by sublimation, the white solid was heated at 100° C. under a pressure of 2.5 Pa with a flow rate of argon gas of 5 mL/min. After the purification by sublimation, 1.0 g of a white solid was obtained in a yield of 71%.

This compound was identified as 4-(trans-4-n-propylcyclohexyl)-3′,4′,5′-trifluoro-1,1′-biphenyl (abbreviation: CPP-3FFF), which was the substance to be produced, by nuclear magnetic resonance (NMR) spectroscopy.

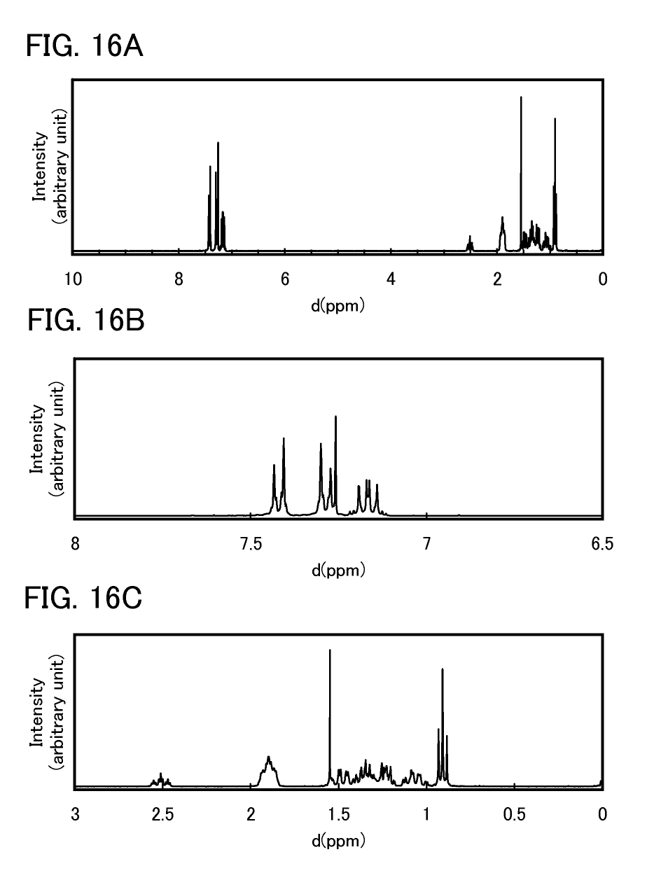

The ¹H NMR data of the obtained substance (CPP-3FFF) is shown below. ¹H NMR (CDCl₃, 300 MHz): δ (ppm)=0.91 (t, 3H), 1.00-1.13 (m, 2H), 1.18-1.55 (m, 7H), 1.86-1.93 (m, 4H), 2.46-2.56 (m, 1H), 7.14-7.19 (m, 2H), 7.29 (d, 2H), 7.42 (d, 2H). In addition, FIGS. 16A to 16C are ¹H NMR charts. Note that FIG. 16B is an enlarged chart showing the range of 6.5 ppm to 8.0 ppm in FIG. 16A. Note also that FIG. 16C is an enlarged chart showing the range of 0.0 ppm to 3.0 ppm in FIG. 16A.

### Synthetic Method of 4-[4-(trans-4-n-propylcyclohexyl)phenyl]benzonitrile (Abbreviation: CPP-3CN)

A synthetic scheme of CPP-3CN represented by the structural formula (111) is shown in (C-1) below.

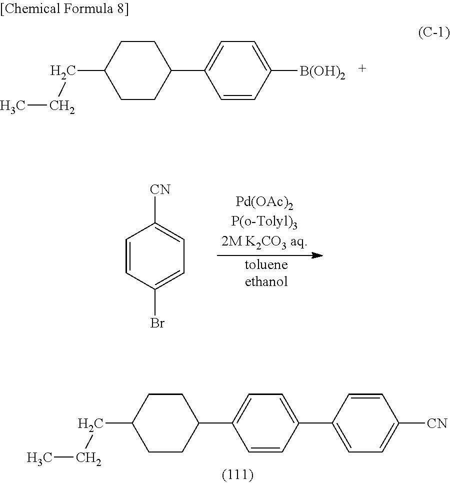

Into a 200-mL three-neck flask were put 2.5 g (10 mmol) of 4-(trans-4-n-propylcyclohexyl)phenylboronic acid, 1.8 g (10 mmol) of 4-bromobenzonitrile, and 0.15 g (0.49 mmol) of tris(2-methylphenyl)phosphine, and the atmosphere in the flask was replaced with nitrogen. To the mixture, 10 mL of 2.0M potassium carbonate solution, 25 mL of toluene, and 25 mL of ethanol were added and this mixture was degassed by being stirred under reduced pressure. To the mixture, 22 mg (98 μmol) of palladium (II) acetate was added and this mixture was stirred at 100° C. for 3 hours under a nitrogen stream. After predetermined time passed, water was added to the obtained mixture to extract an aqueous layer with toluene. The obtained extract and an organic layer were combined, and the mixture was washed with saturated saline and then dried with magnesium sulfate. This mixture was separated by gravity filtration, and the filtrate was concentrated to give an oily substance. This oily substance was purified by silica gel column chromatography (developing solvent: toluene and hexane (toluene:hexane=1:9 then 1:2)). The obtained fraction was condensed to give a solid. This solid was purified by high performance liquid chromatography (HPLC) (developing solvent: chloroform). The obtained fraction was concentrated to give 1.5 g of a white solid, which was a substance to be produced, in a yield of 50%.

Then, 1.5 g of the obtained white solid was purified by sublimation using a train sublimation method. In the purification by sublimation, the white solid was heated at 130° C. under a pressure of 2.4 Pa with a flow rate of argon gas of 5 mL/min. After the purification by sublimation, 1.4 g of a white solid was obtained in a yield of 93%.

This compound was identified as 4-[4-(trans-4-n-propylcyclohexyl)phenyl]benzonitrile (abbreviation: CPP-3CN), which was the substance to be produced, by nuclear magnetic resonance (NMR) spectroscopy.

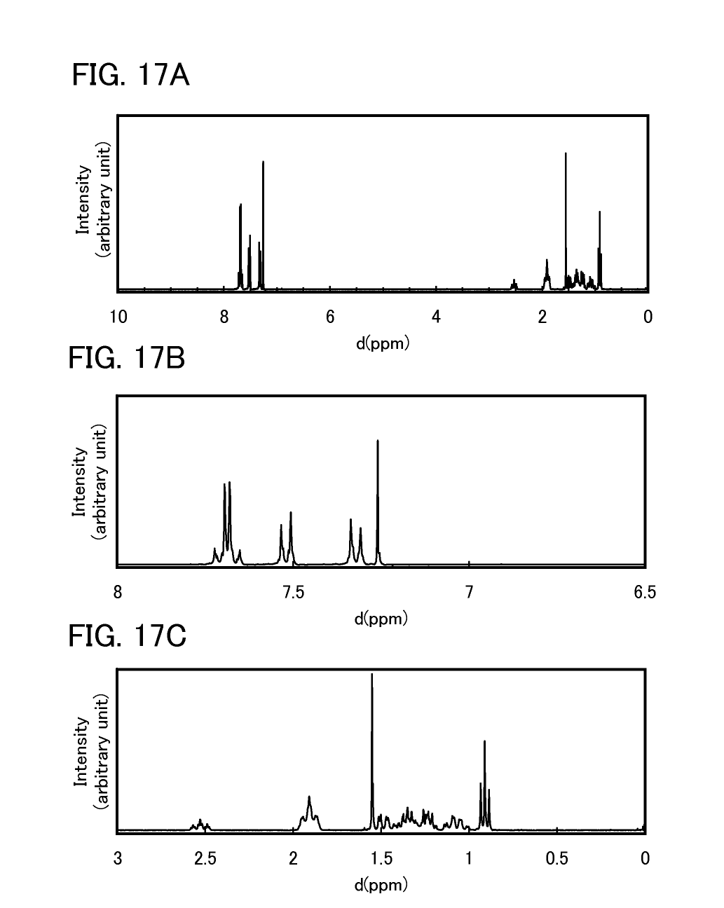

The ¹H NMR data of the obtained substance (CPP-3CN) is shown below. ¹H NMR (CDCl₃, 300 MHz): δ (ppm)=0.91 (t, 3H), 1.00-1.14 (m, 2H), 1.19-1.52 (m, 7H), 1.86-1.94 (m, 4H), 2.48-2.57 (m, 1H), 7.32 (d, 2H), 7.52 (d, 2H), 7.65-7.72 (m, 4H). In addition, FIGS. 17A to 17C are ¹H NMR charts. Note that FIG. 17B is an enlarged chart showing the range of 6.5 ppm to 8.0 ppm in FIG. 17A. Note also that FIG. 17C is an enlarged chart showing the range of 0.0 ppm to 3.0 ppm in FIG. 17A.

### Synthetic Method of 4-(trans-4-n-pentylcyclohexyl)benzoic acid 4-cyano-3,5-difluorophenyl (Abbreviation: CPEP-5FCNF)

A synthetic scheme of CPEP-5FCNF represented by the structural formula (103) is shown in (A-1) below.

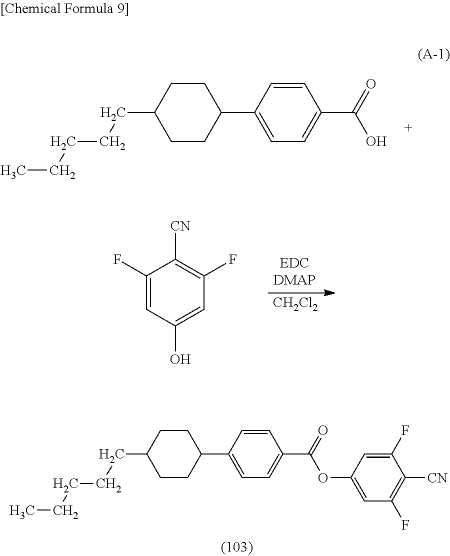

Into a 50-mL recovery flask were put 1.9 g (6.9 mmol) of 4-(trans-4-n-pentylcyclohexyl)benzoic acid, 1.1 g (7.1 mmol) of 2,6-difluoro-4-hydroxybenzonitrile, 0.13 mg (1.1 mmol) of 4-(N,N-dimethylamino)pyridine (DMAP), and 7.0 mL of dichloromethane, and stirring was performed. To this mixture, 1.5 g (7.8 mmol) of 1-ethyl-3-(3-dimethylaminopropyl)carbodiimide hydrochloride (EDC) was added, and stirring was performed in the air at room temperature for 28 hours. After predetermined time passed, water was added to the obtained mixture to extract an aqueous layer with dichloromethane. The obtained extract and an organic layer were combined, and the mixture was washed with saturated saline and then dried with magnesium sulfate. This mixture was separated by gravity filtration, and the filtrate was concentrated to give a solid. This solid was purified by silica gel column chromatography (developing solvent: toluene). The obtained fraction was condensed to give a solid. This solid was purified by high performance liquid chromatography (HPLC) (developing solvent: chloroform).

The obtained fraction was concentrated to give 2.0 g of a white solid, which was a substance to be produced, in a yield of 69%. Then, 2.0 g of the obtained white solid was purified by sublimation using a train sublimation method. In the purification by sublimation, the white solid was heated at 155° C. under a pressure of 2.7 Pa with a flow rate of argon gas of 5 mL/min. After the purification by sublimation, 1.8 g of a white solid was obtained in a yield of 90%.

This compound was identified as 4-(trans-4-n-pentylcyclohexyl)benzoic acid 4-cyano-3,5-difluorophenyl (abbreviation: CPEP-5FCNF), which was the substance to be produced, by nuclear magnetic resonance (NMR) spectroscopy.

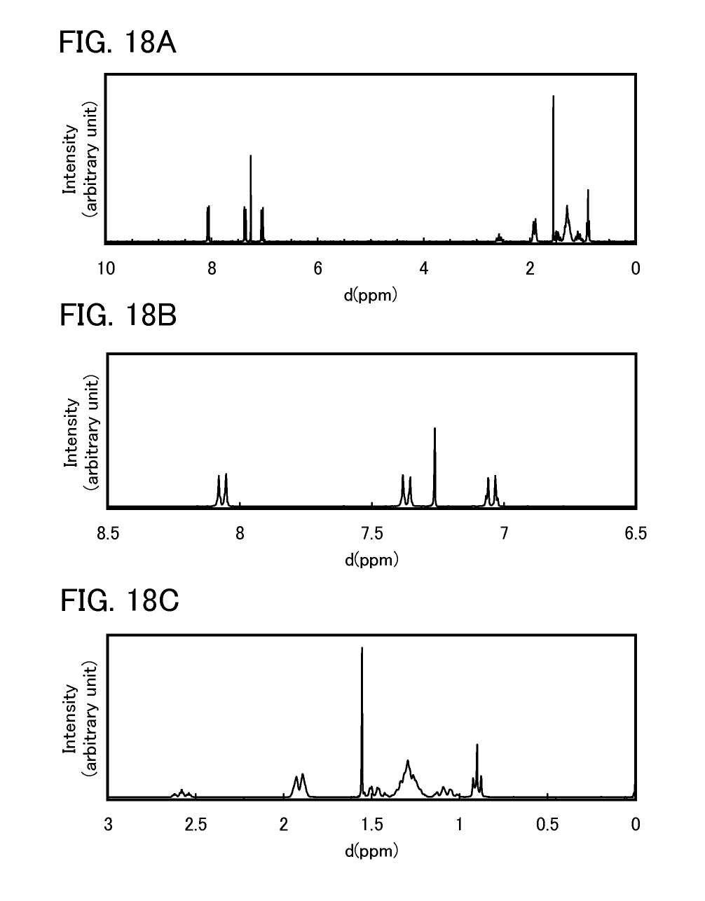

The ¹H NMR data of the obtained substance (CPEP-5FCNF) is shown below. ¹H NMR (CDCl₃, 300 MHz): δ (ppm)=0.90 (t, 3H), 1.02-1.13 (m, 2H), 1.20-1.35 (m, 9H), 1.43-1.54 (m, 2H), 1.89-1.93 (m, 4H), 2.54-2.62 (m, 1H), 7.05 (d, 2H), 7.37 (d, 2H), 8.06 (d, 2H). In addition, FIGS. 18A to 18C are ¹H NMR charts. Note that FIG. 18B is an enlarged chart showing the range of 6.5 ppm to 8.5 ppm in FIG. 18A. Note also that FIG. 18C is an enlarged chart showing the range of 0.0 ppm to 3.0 ppm in FIG. 18A.

### Synthetic Method of 4-n-propylbenzoic acid 3,5-difluoro-4-cyanophenyl (Abbreviation: PEP-3FCNF)

A synthetic scheme of PEP-3FCNF represented by the structural formula (104) is shown in (B-1) below.

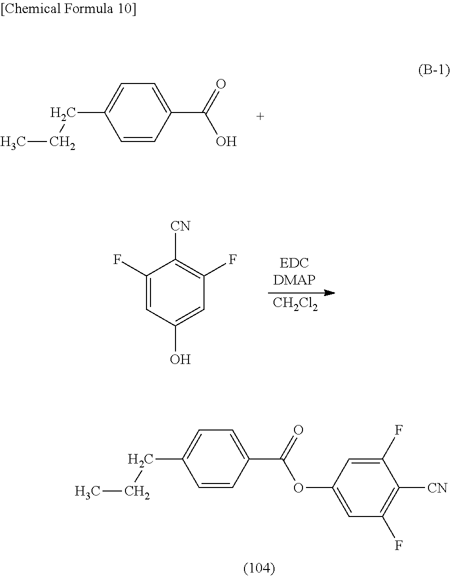

Into a 50-mL recovery flask were put 1.6 g (10.0 mmol) of 4-n-propylbenzoic acid, 1.6 g (10.0 mmol) of 2,6-difluoro-4-hydroxybenzonitrile, 185 mg (1.5 mmol) of (4-N,N-dimethylamino)pyridine, and 10 mL of dichloromethane, and stirring was performed. To this mixture, 2.1 g (11.0 mmol) of 1-ethyl-3-(3-dimethylaminopropyl)carbodiimide hydrochloride (EDC) was added, and stirring was performed in the air at room temperature for 15 hours. After predetermined time passed, water was added to the obtained mixture to extract an aqueous layer of this mixture with dichloromethane. The obtained extract and an organic layer are combined, and the mixture was washed with a saturated sodium hydrogencarbonate solution and saturated saline together with and then dried with magnesium sulfate. This mixture was separated by gravity filtration, and the filtrate was concentrated to give a white solid. This solid was purified by silica gel column chromatography (developing solvent: toluene). The obtained fraction was condensed to give a white solid. This solid was purified by high performance liquid chromatography (HPLC) (developing solvent: chloroform). The obtained fraction was concentrated to give 2.36 g of a white solid, which was a substance to be produced, in a yield of 79%.

Then, the obtained white solid was purified by sublimation using a train sublimation method. In the purification by sublimation, the white solid was heated at 130° C. under a pressure of 2.1 Pa with a flow rate of argon gas of 10 mL/min. After the purification by sublimation, 1.27 g of a white solid was obtained in a yield of 42%.

This compound was identified as 4-n-propylbenzoic acid 3,5-difluoro-4-cyanophenyl (abbreviation: PEP-3FCNF), which was the substance to be produced, by nuclear magnetic resonance (NMR) spectroscopy.

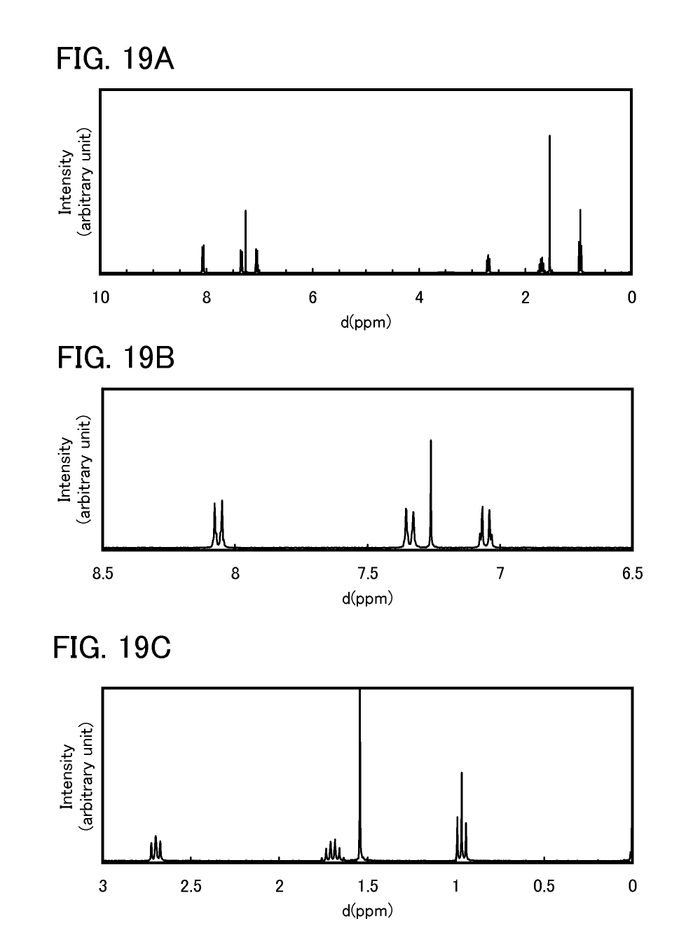

The ¹H NMR data of the obtained substance (PEP-3FCNF) is shown below. ¹H NMR (CDCl₃, 300 MHz): δ (ppm)=0.97 (t, 3H), 1.63-1.76 (m, 2H), 2.70 (t, 2H), 7.05 (d, 2H), 7.34 (d, 2H), 8.06 (d, 2H). In addition, FIGS. 19A to 19C are ¹H NMR charts. Note that FIG. 19B is an enlarged chart showing the range of 6.5 ppm to 8.5 ppm in FIG. 19A. Note also that FIG. 19C is an enlarged chart showing the range of 0.0 ppm to 3.0 ppm in FIG. 19A.

### Synthetic Method of 4-(trans-4-n-pentylcyclohexyl)benzoic acid 4-cyano-3-fluorophenyl (Abbreviation: CPEP-5CNF)

A synthetic scheme of CPEP-5CNF represented by the structural formula (113) is shown in (F-1) below.

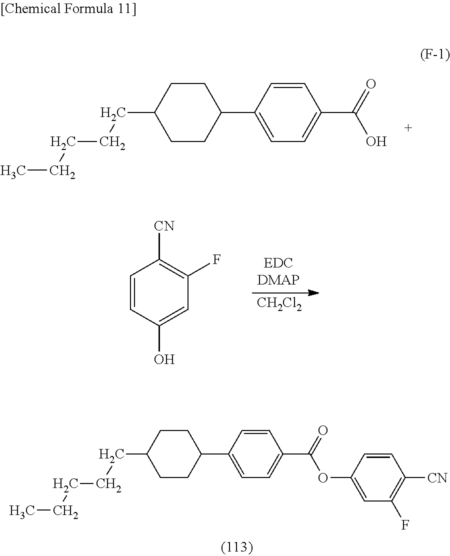

Into a 50-mL recovery flask were put 2.2 g (8.0 mmol) of 4-(trans-4-n-pentylcyclohexyl)benzoic acid, 1.1 g (8.0 mmol) of 2-fluoro-4-hydroxybenzonitrile, 0.15 g (1.2 mmol) of 4-(N,N-dimethylamino)pyridine (DMAP), and 8.0 mL of dichloromethane, and stirring was performed. To this mixture, 1.7 g (8.9 mmol) of 1-ethyl-3-(3-dimethylaminopropyl)carbodiimide hydrochloride (EDC) was added, and stirring was performed in the air at room temperature for 28 hours. After predetermined time passed, water was added to the obtained mixture to extract an aqueous layer with dichloromethane. The obtained extract and an organic layer were combined, and the mixture was washed with saturated saline and then dried with magnesium sulfate. This mixture was separated by gravity filtration, and the filtrate was concentrated to give a solid. This solid was purified by silica gel column chromatography (developing solvent: toluene). The obtained fraction was condensed to give a white solid. This solid was purified by high performance liquid chromatography (HPLC) (developing solvent: chloroform). The obtained fraction was concentrated to give 2.5 g of a white solid, which was a substance to be produced, in a yield of 81%.

Then, 2.5 g of the obtained white solid was purified by sublimation using a train sublimation method. In the purification by sublimation, the white solid was heated at 155° C. under a pressure of 2.5 Pa with a flow rate of argon gas of 5 mL/min. After the purification by sublimation, 2.1 g of a white solid was obtained in a yield of 84%.

This compound was identified as 4-(trans-4-n-pentylcyclohexyl)benzoic acid 4-cyano-3-fluorophenyl (abbreviation: CPEP-5CNF), which was the substance to be produced, by nuclear magnetic resonance (NMR) spectroscopy.

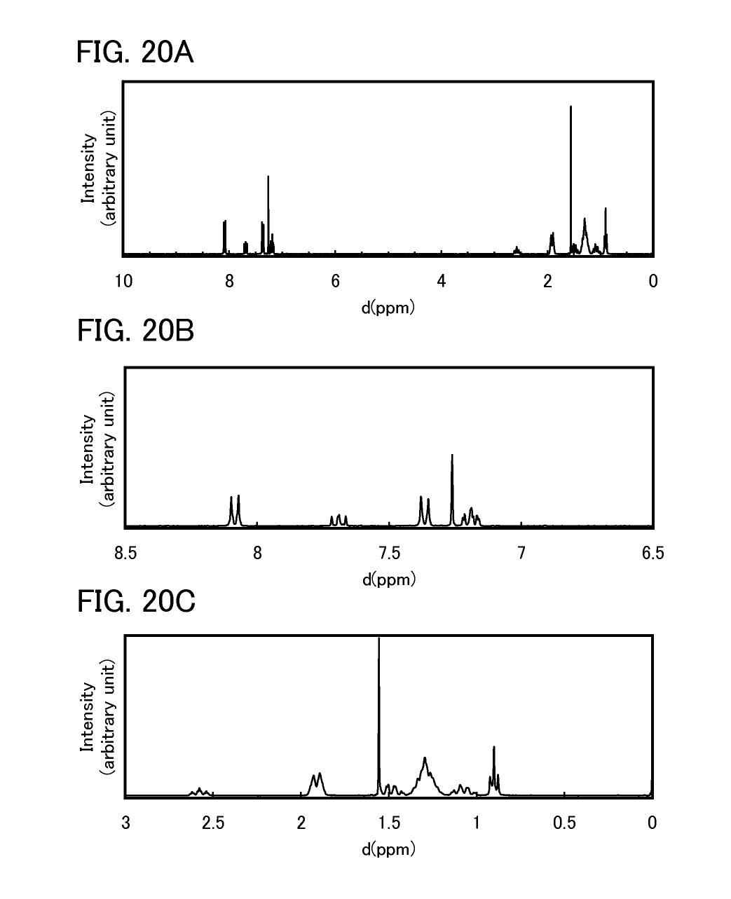

The ¹H NMR data of the obtained substance (CPEP-5CNF) is shown below. ¹H NMR (CDCl₃, 300 MHz): δ (ppm)=0.90 (t, 3H), 1.02-1.13 (m, 2H), 1.20-1.35 (m, 9H), 1.43-1.56 (m, 2H), 1.89-1.93 (m, 4H), 2.54-2.62 (m, 1H), 7.16-7.22 (m, 2H), 7.37 (d, 2H), 7.66-7.72 (m, 1H), 8.08 (d, 2H). In addition, FIGS. 20A to 20C are ¹H NMR charts. Note that FIG. 20B is an enlarged chart showing the range of 6.5 ppm to 8.5 ppm in FIG. 20A. Note also that FIG. 20C is an enlarged chart showing the range of 0.0 ppm to 3.0 ppm in FIG. 20A.

### Synthetic Method of 4-n-propyl benzoic acid 3-fluoro-4-cyanophenyl (Abbreviation: PEP-3CNF)

A synthetic scheme of PEP-3CNF represented by the structural formula (114) is shown in (G1) below.

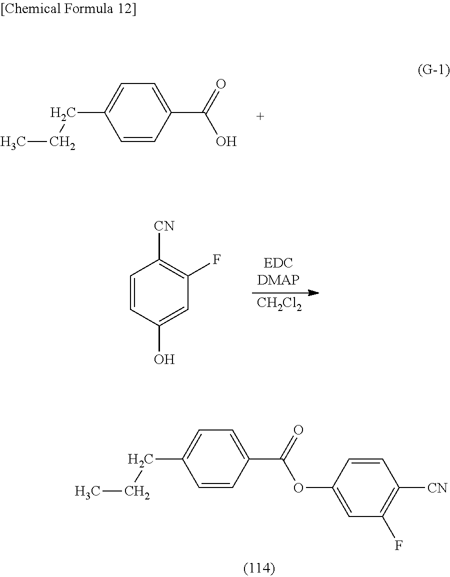

Into a 50-mL recovery flask were put 1.7 g (10.6 mmol) of 4-n-propylbenzoic acid, 1.5 g (10.6 mmol) of 2-fluoro-4-hydroxybenzonitrile, 195 mg (1.6 mmol) of (4-N,N-dimethylamino)pyridine (DMAP), and 10.6 mL of dichloromethane, and stirring was performed. To this mixture, 2.2 g (11.7 mmol) of 1-ethyl-3-(3-dimethylaminopropyl)carbodiimide hydrochloride (EDC) was added, and stirring was performed in the air at room temperature for 15 hours. After predetermined time passed, water was added to the obtained mixture to extract an aqueous layer with dichloromethane. The obtained extract and an organic layer were combined, and the mixture was washed with a saturated sodium hydrogencarbonate solution and saturated saline and then dried with magnesium sulfate. This mixture was separated by gravity filtration, and the filtrate was concentrated to give a colorless oily substance. This oily substance was purified by silica gel column chromatography (developing solvent: toluene). The obtained fraction was condensed to give a colorless oily substance. This oily substance was purified by high performance liquid chromatography (HPLC) (developing solvent: chloroform). The obtained fraction was concentrated to give 2.47 g of a colorless oily substance, which was a substance to be produced, in a yield of 82%.

Then, the obtained colorless oily substance was purified by sublimation using a train sublimation method. In the purification by sublimation, the colorless oily substance was heated at 150° C. under a pressure of 2.0 Pa with a flow rate of argon gas of 10 mL/min. After the purification by sublimation, 0.78 g of the colorless oily substance was obtained in a yield of 26%.

This compound was identified as 4-n-propylbenzoic acid 3-fluoro-4-cyanophenyl (abbreviation: PEP-3CNF), which was the substance to be produced, by nuclear magnetic resonance (NMR) spectroscopy.

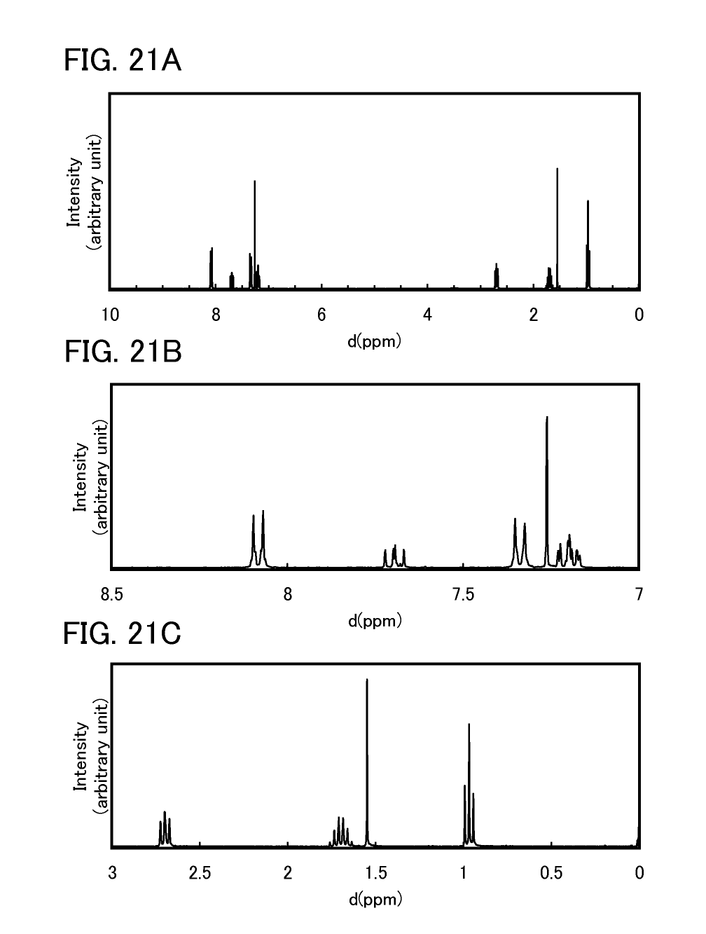

The ¹H NMR data of the obtained substance (PEP-3CNF) is shown below. ¹H NMR (CDCl₃, 300 MHz): δ (ppm)=0.97 (t, 3H), 1.63-1.76 (m, 2H), 2.70 (t, 2H), 7.17-7.23 (m, 2H), 7.34 (d, 2H), 7.67-7.72 (m, 1H), 8.08 (d, 2H). In addition, FIGS. 21A to 21C are ¹H NMR charts. Note that FIG. 21B is an enlarged chart showing the range of 7.0 ppm to 8.5 ppm in FIG. 21A. Note also that FIG. 21C is an enlarged chart showing the range of 0.0 ppm to 3.0 ppm in FIG. 21A.

This application is based on Japanese Patent Application serial no. 2010-263468 filed with the Japan Patent Office on Nov. 26, 2010, the entire contents of which are hereby incorporated by reference.

What is claimed is:

1. A liquid crystal composition being capable of exhibiting a blue phase, the liquid crystal composition comprising:
a chiral agent; and
a liquid crystal comprising a compound including three electron-withdrawing groups as end groups of a structure,
wherein, in the structure, a plurality of rings including at least one aromatic ring are linked to each other directly or with a linking group laid therebetween, and
wherein a peak of a diffracted wavelength on a longest wavelength side in a reflectance spectrum is less than or equal to 450 nm.

2. The liquid crystal composition according to claim 1,
wherein the plurality of rings includes cycloalkane.

3. The liquid crystal composition according to claim 1,
wherein the three electron-withdrawing groups are coupled to one of the plurality of rings.

4. The liquid crystal composition according to claim 1,
wherein each of the electron-withdrawing groups is a cyano group or fluorine.

5. The liquid crystal composition according to claim 1,
wherein the peak of the diffracted wavelength is less than or equal to 420 nm.

6. The liquid crystal composition according to claim 1,
wherein the compound is contained in the liquid crystal at 40 wt % or more.

7. The liquid crystal composition according to claim 1,
wherein the chiral agent is contained in the liquid crystal composition at 10 wt % or less.

8. The liquid crystal composition according to claim 1,
wherein the linking group is any of an ester group, an ethyne-1,2-diyl group, an aldimine-1,2-diyl group, an azo group, a difluoromethylether-1,2-diyl group, a methylether-1,2-diyl group, and an ethane-1,2-diyl group.

9. A liquid crystal display device comprising the liquid crystal composition according to claim 1.

10. A liquid crystal composition being capable of exhibiting a blue phase, the liquid crystal composition comprising:
a chiral agent; and
a liquid crystal comprising a compound including three electron-withdrawing groups as end groups of a structure,
wherein the structure includes a first aromatic ring and a second aromatic ring, the first aromatic ring and the second aromatic ring being linked to each other directly or with a linking group laid therebetween, and
wherein a peak of a diffracted wavelength on a longest wavelength side in a reflectance spectrum is less than or equal to 450 nm.

11. The liquid crystal composition according to claim 10,
wherein at least one of the first aromatic ring and the second aromatic ring is cycloalkane.

12. The liquid crystal composition according to claim 10,
wherein the three electron-withdrawing groups are coupled to the first aromatic ring.

13. The liquid crystal composition according to claim 10,
wherein each of the three electron-withdrawing groups is a cyano group or fluorine.

14. The liquid crystal composition according to claim 10,
wherein the peak of the diffracted wavelength is less than or equal to 420 nm.

15. The liquid crystal composition according to claim 10,
wherein the compound is contained in the liquid crystal at 40 wt % or more.

16. The liquid crystal composition according to claim 10,
wherein the chiral agent is contained in the liquid crystal composition at 10 wt % or less.

17. The liquid crystal composition according to claim 10,
wherein the linking group is any of an ester group, an ethyne-1,2-diyl group, an aldimine-1,2-diyl group, an azo group, a difluoromethylether-1,2-diyl group, a methylether-1,2-diyl group, and an ethane-1,2-diyl group.

18. A liquid crystal device comprising the liquid crystal composition according to claim 10.
